(19) United States
(12) Patent Application Publication
(10) Pub. No.: US 2025/0319439 A1
(43) Pub. Date: Oct. 16, 2025

(54) PRE-TREATMENT OF SEAWATER

(71) Applicant: ACWA POWER Company, Riyadh (SA)

(72) Inventor: Ratul DAS, Thuwal (SA)

(73) Assignee: ACWA POWER Company, Riyadh (SA)

(21) Appl. No.: 19/175,724

(22) Filed: Apr. 10, 2025

Related U.S. Application Data
(60) Provisional application No. 63/634,363, filed on Apr. 15, 2024.

(51) Int. Cl. B01D 61/04; B01D 61/02; B01D 61/12; B01D 61/14; B01D 61/22; B01D 61/58; B01D 69/02; B01D 69/10; B01D 71/02; C02F 1/00; C02F 1/44; C02F 9/00; C02F 101/30; C02F 103/08

(52) U.S. Cl. CPC B01D 61/04; B01D 61/12; B01D 61/22; B01D 61/58; B01D 69/02; B01D 69/107; B01D 71/0211; C02F 1/008; C02F 9/00; B01D 61/025; B01D 61/145; B01D 2313/901; B01D 2317/02; B01D 2325/04; C02F 1/004; C02F 1/441; C02F 1/444; C02F 2101/30; C02F 2103/08; C02F 2303/04

(57) ABSTRACT

A method, an apparatus and a controller for pre-treatment of seawater is described. The apparatus controls a supply of a seawater stream to a filtration unit, which outputs a first filtered stream based on the supply of the seawater stream. The method further includes controlling a supply of the first filtered stream to a graphene-based ultrafiltration unit. The graphene-based ultrafiltration unit outputs a second filtered stream based on the supply of the first filtered stream. The graphene-based ultrafiltration unit comprises graphene oxide membranes. The method further includes controlling a supply of the second filtered stream to a seawater reverse osmosis (SWRO) membrane unit. The method further includes controlling an outlet of the SWRO membrane unit to output a desalinated stream based on the supply of the second filtered stream.

### CROSS-REFERENCE TO RELATED APPLICATION

This application claims priority to U.S. Provisional Patent Application Ser. No. 63/634,363, filed Apr. 15, 2024 and entitled APPARATUS AND METHOD FOR CHEMICAL-FREE PRE-TREATMENT OF FFEEDWATER FOR REVERSE OSMOSIS, the disclosure which is incorporated herein by reference.

### TECHNOLOGICAL FIELD

The present disclosure relates to seawater desalination systems, and more particularly relates to method, apparatus and controller for pre-treatment of seawater.

### BACKGROUND

Growing population, industrial development, and several such factors have resulted in an increased demand for fresh water supply in various regions globally. Approximately 97% of the available water on Earth is seawater. However, fresh water is required for most day-to-day activities. To address the demand for fresh water, techniques for water filtration, including seawater filtration, have been developed. These techniques primarily focus on eliminating salts and contaminants from seawater to generate fresh water. Reverse osmosis (RO) is a process utilizing one such technique.

RO includes a process of seawater reverse osmosis (SWRO). In RO, a liquid with high solute concentration, such as water, is provided as an input through a permeable or semi-permeable membrane to remove contaminants, and a liquid with low solute concentration is obtained as an output. However, RO suffers from challenges including (but not limited to) membrane fouling and low recycle rates. Membrane fouling refers to an accumulation of contaminants on a surface or within pores of membrane(s) of a system that implements RO. The accumulation can impede flow of the liquid and reduce the membrane(s)'s efficiency for filtration of the liquid. The membrane fouling decreases recycle rates, resulting in increased energy consumption in filtration of the liquid. The membrane fouling also leads to increased frequency of membrane replacement, which increases overall cost involved in filtration of the liquid.

Therefore, there is a need to provide methods and systems of pre-treatment for seawater desalination, such that systems implementing RO do not suffer from frequent membrane fouling, thereby ensuring reduced energy consumption for filtration of seawater to provide desalinated water.

### BRIEF SUMMARY

The present disclosure discloses a method, an apparatus, and a controller for pre-treatment for seawater desalination.

In an embodiment, a method for pre-treatment of seawater is provided. The method includes controlling a supply of a seawater stream to a filtration unit of a pre-treatment unit. The filtration unit outputs a first filtered stream based on the supply of the seawater stream. The method further includes controlling a supply of the first filtered stream to a graphene-based ultrafiltration unit of the pre-treatment unit. The graphene-based ultrafiltration unit outputs a second filtered stream based on the supply of the first filtered stream. The method further includes controlling a supply of the second filtered stream to a seawater reverse osmosis (SWRO) membrane unit. The method further includes controlling an outlet of the SWRO membrane unit to output a desalinated stream based on the supply of the second filtered stream.

In an embodiment, the graphene-based ultrafiltration unit includes a plurality of membranes stacked adjacent to each other. Each of the plurality of membranes includes a substrate and one or more graphene oxide layers arranged on at least one side of the substrate.

In an embodiment, a number of the one or more graphene oxide layers arranged on the substrate of a specific membrane of the plurality of membranes is in a range of 40 to 60, and a thickness of each of the one or more graphene oxide layers is in a range of 0.5 nanometers (nm) to 1.5 nm.

In an embodiment, the filtration unit corresponds to at least one of a gravity-based multimedia filtration unit, a pressurized multimedia-based filtration unit, a membrane-based filtration unit, or an ultrafiltration unit.

In an embodiment, the substrate includes polyvinylidene fluoride (PVDF).

In an embodiment, the filtration unit filters each of a first portion of one or more particulate matters from the seawater stream, and a first portion of one or more microbial matters from the seawater stream, and the graphene-based ultrafiltration unit filters each of a second portion of the one or more particulate matters from the first filtered stream, and a second portion of the one or more microbial matters from the first filtered stream.

In an embodiment, a first summation of the first portion of one or more particulate matters, the first portion of one or more microbial matters, the second portion of the one or more particulate matters and the second portion of the one or more microbial matters corresponds to a total amount of a plurality of entities filtered from the seawater stream to produce the second filtered stream. Each of the plurality of entities corresponds to one of the one or more particulate matters, or the one or more microbial matters. Further, a percentage of the total amount of the plurality of entities filtered from the seawater stream to produce the second filtered stream is in a range of 98.5% to 100%.

In an embodiment, the supply of the second filtered stream to the SWRO membrane unit causes an accumulation of a first quantity of the plurality of entities over a predefined time period on one or more membrane layers in the SWRO membrane unit, such that the first quantity is less than a fouling threshold of the SWRO membrane unit.

In an embodiment, a set of characteristics is associated with the second filtered stream. The set of characteristics is associated with at least one of a dissolved organic carbon value of the second filtered stream, a silt density index (SDI) value of the second filtered stream, a bio-polymer value of the second filtered stream, a turbidity value of the second filtered stream, or a modified fouling index (MFI) value of the second filtered stream.

In an embodiment, at least one of the bio-polymer value of the second filtered stream is in a range of 65% to 100%, the dissolved organic carbon value of the second filtered stream is in a range of 35% to 100%, or the SDI value of the second filtered stream is in a range of 0 to 1, the turbidity value of the second filtered stream is in a range of 0 to 0.5 nephelometric turbidity units (NTU), or the MFI value of the second filtered stream is in a range of 0 to 0.5.

In an embodiment, the seawater stream, the first filtered stream and the second filtered stream are independent of each chemical agent from a set of pre-treatment chemical agents. The set of pre-treatment chemical agents comprises at least one of ferric chloride, sodium hypochlorite, chlorine dioxide, or sulphuric acid.

In an embodiment, an amount of total dissolved solids (TDS) in the seawater stream is in a range among a set of ranges. The set of ranges comprises 12000 to 20000 parts per million (ppm), and 32000 to 50000 ppm.

In another aspect, an apparatus for pre-treatment of seawater is provided. The apparatus includes a pre-treatment unit. The pre-treatment unit further includes a filtration unit and a graphene-based ultrafiltration unit. The apparatus further includes a seawater reverse osmosis (SWRO) membrane unit. The SWRO membrane unit includes one or more membrane layers. The apparatus further includes a controller. The controller further includes one or more processors. The controller is configured to control a supply of a seawater stream to the filtration unit of the pre-treatment unit. The filtration unit outputs a first filtered stream based on the supply of the seawater stream. The controller is further configured to control a supply of the first filtered stream to the graphene-based ultrafiltration unit. The graphene-based ultrafiltration unit outputs a second filtered stream based on the supply of the first filtered stream. The controller is further configured to control a supply of the second filtered stream to the SWRO membrane unit. The controller is further configured to control an outlet of the SWRO membrane unit to output a desalinated stream based on the supply of the second filtered stream.

In an embodiment, the graphene-based ultrafiltration unit comprises a plurality of membranes stacked adjacent to each other, and wherein each of the plurality of membranes comprises a substrate and one or more graphene oxide layers arranged on at least one side of the substrate. Further, a number of the one or more graphene oxide layers arranged on the substrate of a specific membrane of the plurality of membranes is in a range of 40 to 60, and a thickness of each of the one or more graphene oxide layers is in a range of 0.5 nanometres (nm) to 1.5 nm.

In an embodiment, the filtration unit filters each of a first portion of one or more particulate matters from the seawater stream, and a first portion of one or more microbial matters from the seawater stream, and the graphene-based ultrafiltration unit filters each of a second portion of the one or more particulate matters from the first filtered stream, and a second portion of the one or more microbial matters from the first filtered stream.

In an embodiment, a first summation of the first portion of one or more particulate matters, the first portion of one or more microbial matters, the second portion of the one or more particulate matters and the second portion of the one or more microbial matters corresponds to a total amount of a plurality of entities filtered from the seawater stream to produce the second filtered stream, each of the plurality of entities corresponds to one of the one or more particulate matters, or the one or more microbial matters, and a percentage of the total amount of the plurality of entities filtered from the seawater stream to produce the second filtered stream is in a range of 98.5% to 100%.

In an embodiment, the supply of the second filtered stream to the SWRO membrane unit causes an accumulation of a first quantity of the plurality of entities over a predefined time period on one or more membrane layers in the SWRO membrane unit, such that the first quantity is less than a fouling threshold of the SWRO membrane unit.

In an embodiment, the seawater stream, the first filtered stream and the second filtered stream are independent of each chemical agent from a set of pre-treatment chemical agents, and wherein the set of pre-treatment chemical agents comprises at least one of ferric chloride, sodium hypochlorite, chlorine dioxide, or sulphuric acid.

In another aspect, a controller for pre-treatment of seawater is provided. The controller includes one or more processors. The one or more processors are configured to control a supply of a seawater stream to a filtration unit of a pre-treatment unit. The filtration unit outputs a first filtered stream based on the supply of the seawater stream. The one or more processors are further configured to control a supply of the first filtered stream to a graphene-based ultrafiltration unit of the pre-treatment unit. The graphene-based ultrafiltration unit outputs a second filtered stream based on the supply of the first filtered stream. The one or more processors are further configured to control a supply of the second filtered stream to a seawater reverse osmosis (SWRO) membrane unit. The one or more processors are further configured to control an outlet of the SWRO membrane unit to output a desalinated stream based on the supply of the second filtered stream.

In an embodiment, the graphene-based ultrafiltration unit comprises a plurality of membranes stacked adjacent to each other, and wherein each of the plurality of membranes comprises a substrate and one or more graphene oxide layers arranged on at least one side of the substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of an apparatus for seawater desalination, in accordance with an embodiment of the present disclosure;

FIG. 2 illustrates a block diagram of a controller for seawater desalination, in accordance with an embodiment of the present disclosure;

FIG. 3 illustrates an exemplary block diagram of the apparatus for desalination of a seawater stream, in accordance with an embodiment of the present disclosure;

FIG. 4 illustrates an exemplary flowchart of a method for pre-treatment of seawater, in accordance with an embodiment of the present disclosure;

FIG. 5A illustrates first experimental data related to reduction in microbial matters, in accordance with an embodiment of the present disclosure;

FIG. 5B illustrates second experimental data related to reduction in microbial matters, in accordance with an embodiment of the present disclosure;

FIG. 5C illustrates third experimental data related to reduction in microbial matters, in accordance with an embodiment of the present disclosure;

FIG. 6A illustrates first experimental data related to reduction in particulate matters, in accordance with an embodiment of the present disclosure;

FIG. 6B illustrates second experimental data related to reduction in particulate matters, in accordance with an embodiment of the present disclosure;

FIG. 6C illustrates third experimental data related to reduction in particulate matters, in accordance with an embodiment of the present disclosure;

FIG. 7 illustrates experimental data related to removal of dissolved organic carbon by graphene-based ultrafiltration unit, in accordance with an embodiment of the present disclosure;

FIG. 8A illustrates first experimental data related to SDI and MFI values, in accordance with an embodiment of the present disclosure;

FIG. 8B illustrates second experimental data related to SDI and MFI values, in accordance with an embodiment of the present disclosure;

FIG. 8C illustrates third experimental data related to SDI and MFI values, in accordance with an embodiment of the present disclosure;

FIG. 9A illustrates first experimental data related to reduction in turbidity, in accordance with an embodiment of the present disclosure;

FIG. 9B illustrates second experimental data related to reduction in turbidity, in accordance with an embodiment of the present disclosure; and

FIG. 9C illustrates third experimental data related to reduction in turbidity, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Freshwater shortage is a problem owing to reasons such as, but not limited to, extreme weather conditions, desertification, and water pollution. As freshwater nourishes and sustains life, incessant population growth demands a greater supply of freshwater. While freshwater generation technologies exist, rate of production of freshwater has not been adequate to meet growing demands. Accordingly, a low-cost and energy-efficient seawater desalination process is needed for addressing the growing demands for freshwater.

Membrane-based filtration process is an existing technology for freshwater generation. In general, the membrane-based filtration process generates a permeate and a brine stream as an output from an input of seawater stream. The permeate includes filtered or desalinated portion of the input of seawater stream, whereas the brine stream includes the contaminants from the input. Reverse osmosis (RO), such as, seawater reverse osmosis (SWRO), is a membrane-based filtration process. SWRO is specifically designed to desalinate seawater, which has a high salt concentration. Systems implementing SWRO use high-pressure pumps to force seawater through a semi-permeable membrane that allows water molecules to pass through, while restricting salts and other impurities.

RO is a water purification process that uses a membrane, which can be semi-permeable, to remove contaminants from a liquid, such as, but not limited to, water. Pertinently, the terms “contaminants”, “impurities”, and/or “undesired materials” may be used interchangeably throughout the present disclosure, and refer to substances that can adversely affect the quality, safety, or usability of the liquid. Also, for sake of clarity, it is pertinent to mention that the terms “liquid” and “water” may be used interchangeably throughout the present disclosure, and the term liquid encompasses water but is not limited to water. Also, the terms “amount” and “quantity” may be used interchangeably throughout the present disclosure. In RO, a pressure is applied to the liquid on a first side of the membrane, forcing the liquid to pass through the membrane to a second side of the membrane while leaving contaminants, such as salts, and bacteria on the first side. Water devoid of contaminants that passes through the membrane is collected on the second side, while the contaminants that are concentrated with impurities may be discarded from the first side.

Current systems implementing RO approach a theoretical limit of specific energy consumption (SEC) for the process of RO of freshwater generation. The SEC for RO refers to an amount of energy required to produce a specific volume of filtered water output from a feed of water input. A lower SEC value indicates a higher energy-efficient process, and vice versa. The current standard SEC limit is around 1.5 Kilowatt-hours per cubic meters (kWh/m³). The operational cost for SWRO depends on factors including, but not limited to, high energy consumption due to membrane fouling, membrane servicing, and membrane replacement costs. Membrane fouling refers to an accumulation of unwanted materials on a surface(s) of the membrane(s) or within pores of the membrane(s) of the RO system, which can impede flow of water and reduce the membrane's efficiency for filtration of the water. Membrane fouling may occur due to factors, such as, but not limited to, organic fouling (accumulation of natural organic compounds, proteins, and polysaccharides, on surface(s) of the membrane), inorganic fouling (accumulation of inorganic salts, such as calcium carbonate or silica, which can form scaling of the membrane), biofouling (growth of microorganisms, including bacteria and algae, on surface(s) of the membrane, leading to a biofilm that can further obstruct water flow), and particulate fouling (accumulation of suspended solids, such as silt, and clay, which can physically block pores of the membrane). Servicing and subsequent replacement of the membranes due to membrane fouling are unavoidable. However, frequency of the servicing and the replacement of the membrane, and energy consumption due to RO can be managed by providing filtered water with minimal particulate matter and microbial cells as an input to the systems implementing RO.

Traditional systems for providing filtered water or pre-treated water for RO involve use of chemicals as coagulants, or disinfectants while pre-treating the water. The coagulants include, but are not limited to, Ferric Chloride. The disinfectants include, but are not limited to, Sodium Hypochlorite and Chlorine dioxide. The coagulants and disinfectants may reduce operational costs. For example, Sodium Hypochlorite is used as a disinfectant; however, Sodium Hypochlorite while treating water produces disinfection by-products, such as but not limited to, trihalomethanes (THMs) and haloacetic acids (HAAs), which degrade membranes used in the RO by accumulating on the surface of the membranes. Thus, use of coagulants and disinfectants may also result in increased growth of microbial cells on membrane(s) of the systems implementing RO, which further leads to issues such as increased energy consumption and costs, as discussed above. Thus, a solution is needed to overcome the issues associated with the traditional systems for providing filtered water or pre-treated water for the process of RO.

Embodiments of the present disclosure will be described hereinafter with reference to the accompanying drawings, in which some, but not all, embodiments of the disclosure are shown. Embodiments of the present disclosure may be embodied in many different forms and should not be construed as limiting; rather, the embodiments are provided so that the present disclosure will satisfy applicable legal requirements. Like reference numerals refer to like elements throughout. Also, reference in the present disclosure to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

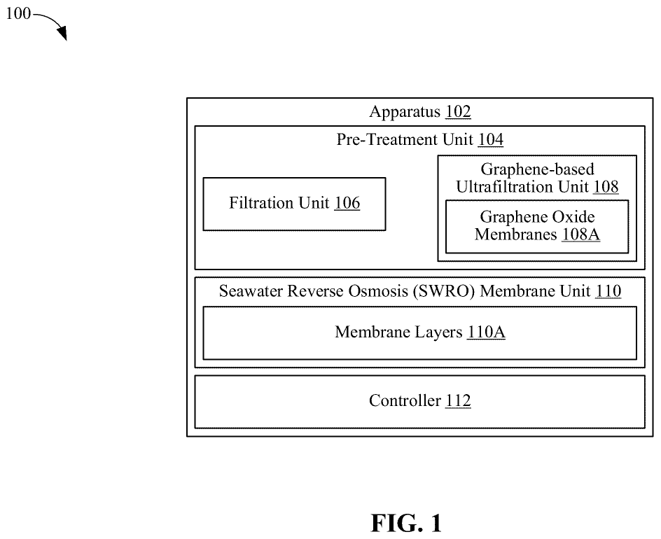

The embodiments are described herein for illustrative purposes and are subject to many variations. It is understood that omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within the description is for convenience only and has no legal or limiting effect. Turning now to FIG. 1-FIG. 9C, a brief description concerning the various components of the present disclosure will now be briefly discussed.

Referring to FIG. 1, block diagram 100 illustrates a configuration for pre-treatment of seawater, in accordance with an embodiment of the present disclosure. The block diagram 100 may include an apparatus 102, which may further include a pre-treatment unit 104, a seawater reverse osmosis (SWRO) membrane unit 110, and a controller 112. The SWRO membrane unit 110 may further include one or more membrane layers 110A (also referred to as membrane layers 110A). The pre-treatment unit 104 may further include a filtration unit 106 and a graphene-based ultrafiltration unit 108. The filtration unit 106 may be a gravity-based multimedia filtration unit, a pressurized multimedia-based filtration unit, and a membrane-based filtration unit. The graphene-based ultrafiltration unit 108 may further include one or more graphene oxide membranes 108A. An output of the SWRO membrane unit 110 of the apparatus 102 may include a desalinated stream (i.e., filtered liquid or permeate) and a brine stream. Pertinently, the SWRO membrane unit 110 may implement a membrane-based filtration process such as, but not limited to, reverse osmosis, nanofiltration, forward osmosis.

The pre-treatment unit 104 refers to a system that may filter or pre-treat a water stream before the water stream undergoes filtration by the SWRO membrane unit 110. The pre-treatment unit 104 reduces overall number of particulate matters or microbial matters in the filtered water stream that is produced by the pre-treatment unit 104, as compared to the input stream, which includes the seawater stream. The pre-treatment of water stream reduces the membrane fouling of one or more membrane layers 110A in the SWRO membrane unit 110 due to overall reduction in the number of particulate matters or microbial matters, which are major causes of membrane fouling. Further, the pre-treatment of the input stream also reduces accumulation of particulate matters or microbial matters on the one or more membrane layers 110A in the SWRO membrane unit 110, thereby increasing rate of flow of water through the one or more membrane layers 110A in the SWRO membrane unit 110 and reducing overall energy consumption in the filtration process.

The apparatus 102 may include suitable logic, circuitry, interfaces, and/or code to filtrate the seawater stream. Also, the apparatus may be useful in SWRO, particularly for providing pre-treated water for SWRO. The apparatus 102 may be configured to control the input stream of seawater to the filtration unit 106 to output a first filtered stream. The apparatus 102 may be further configured to control an input supply of the first filtered stream to the graphene-based ultrafiltration unit 108 to output a second filtered stream. The apparatus 102 may be further configured to control an input supply of the second filtered stream to the SWRO membrane unit 110 to output a desalinated stream and a brine stream. The SWRO membrane unit 110 may include one or more membrane layers 110A. The membrane layers 110A include semi-permeable membranes. The desalinated stream may refer to the filtered liquid that is an output from the one or more membrane layers 110A of the SWRO membrane unit 110. Further, the brine stream may refer to concentrates, which contains rejected contaminants and remains that do not filter through the one or more membrane layers 110A of the SWRO membrane unit 110.

In an embodiment, the controller 112 of the apparatus 102 may be configured to control an input supply of the seawater stream to the filtration unit 106 to output the first filtered stream. The seawater stream may refer to a stream of water that is directly obtained from sea or ocean and may contain a significant concentration of dissolved substances, including particulate matter and microbial matter. In general, waste from various sources such as, but not limited to, industrial wastewater, municipal wastewater, leachate, frac water, oilfield produced water, etc. may get dissolved in seawater. The filtration unit 106 may implement a unique of a combination of filtration techniques, which include but is not limited to a gravity-based multimedia filtration, a pressurized multimedia-based filtration, or a membrane-based filtration, or an ultrafiltration. The filtration technique(s) or their combination may be used to obtain the first filtered stream as an output of the filtration unit 106, which is configured to remove a first portion of one or more particulate matters and a first portion of one or more microbial matters that may be present in the seawater stream.

The gravity-based multimedia filtration technique utilizes force of gravity to filter the seawater stream. A system implementing the gravity-based multimedia filtration technique may include a series of chambers or tanks filled with a plurality of filter media. The plurality of filter media may be present in various layers of the system implementing the gravity-based multimedia filtration technique. The seawater stream may transit layers of the plurality of filter media, in sequence. The first filtered stream may be obtained as an output of the plurality of filter media.

A system that implements the pressurized multimedia filtration technique may utilize a mechanical pump and a pressure filtration vessel. The mechanical pump may generate high pressure for forcing the seawater stream through the pressure filtration vessel. The pressure filtration vessel may include multiple layers of filtration media. The seawater stream may be pressurized and forced through the multiple layers of the filtration media. The contaminants may be physically retained based on size and molecular weight. For example, a layer of the filtration media includes coarse gravel. Gap between particles of the filtration media in the layer of the filtration media acts as a limitation to particle size of the contaminants that can pass through the layer of the coarse gravel. Similarly, for example, another layer of filtration media includes sand particles. The sand particles may be smaller in size than the coarse gravel and therefore, gap between the sand particles is smaller than the gap between the particles of the coarse gravel. Therefore, the particle size of the contaminants that is blocked by the layer of the sand particles is smaller than the particle size of the contaminants that is blocked by the layer of the coarse gravel. Filtered liquid from the system implementing the pressurized multimedia filtration technique that has permeated through the multiple layers of the filtration media may be collected while the retained contaminants may be discharged separately.

A system that implements the membrane-based filtration technique may use semi-permeable membranes to separate and remove contaminants from the seawater stream. The semi-permeable membranes may act as barriers, allowing only desalinated water to permeate through while blocking pollutants, including but not limited to suspended solids, dissolved substances, bacteria, and viruses. The system implementing the membrane-based filtration technique may comprise one or more membranes that allow only certain particles or molecules to transit while retaining larger particulate contaminants, such as suspended solids, bacteria, viruses, and organic matter. As the seawater stream is forced through the membrane(s) of the system implementing the membrane-based filtration technique, the permeate of the seawater stream transits through pores of each of the one or more membranes. The filtered liquid that has permeated through the one or more membranes of the system implementing the membrane-based filtration technique may be collected while the retained contaminants may be discharged separately.

A system that implements the ultrafiltration (UF) technique may use membranes that may separate particles in the seawater based on size. In an embodiment, the size of the particles that may be separated from seawater may range from 0.1 to 0.001 microns. The system operates by applying hydrostatic pressure to push water through a semi-permeable membrane of the system. As water flows, contaminants are retained on one side of the membrane, creating a concentrated retentate, while purified water flows through. The system may operate in various configurations. The various configurations may include, but are not limited to, cross-flow configuration, or dead-end filtration configuration. In the cross-flow configuration, water circulates continuously, which reduces fouling on surface of the semi-permeable membrane of the system. Particularly, in the cross-flow configuration, water flows tangential to membrane surface and retentate is removed from the same side. In the dead-end filtration configuration, water flows perpendicularly through the membrane.

Further, the first filtered stream may be provided as an input to the graphene-based ultrafiltration unit 108. The controller 112 of the apparatus 102 may be configured to control the input supply of the first filtered stream to the graphene-based ultrafiltration unit 108 to obtain a second filtered stream. The graphene-based ultrafiltration unit 108 may use a graphene oxide membrane filtration technique. Consequently, the first filtered stream may be further filtered by the graphene-based ultrafiltration unit 108. The graphene-based filtration technique may involve use of one or more graphene oxide membranes. Thus, the graphene-based ultrafiltration unit 108 may include a plurality of graphene oxide membranes 108A. In an embodiment, the plurality of graphene oxide membranes 108A may be stacked adjacent to each other. Also, each of the plurality of graphene oxide membranes 108A may include a substrate, and one or more graphene oxide layers that may be arranged on at least one side of the substrate. In an embodiment, the substrate may include or be made of Polyvinylidene fluoride (PVDF). Further, in an embodiment, the number of the one or more graphene oxide layers arranged on the substrate of a specific membrane of the plurality of membranes is in a range of 40 to 60. Each graphene oxide membrane of the plurality of graphene oxide membranes 108A may include a substrate and a plurality of graphene oxide layers on the substrate, where the number of graphene oxide layers may range from 40 to 60. In an embodiment, the number of graphene oxide layers may preferably be close to 50. Also, in an embodiment, thickness of each of the plurality graphene oxide layers is in a range of 0.5 nanometers (nm) to 1.5 nm, and preferably close to 1 nm. In yet another embodiment, each graphene oxide membrane of the plurality of graphene oxide membranes 108A has 50 layers of graphene oxide, where the thickness of each graphene oxide layer is 1 nm, then the thickness of that graphene oxide membrane may be close to 50 nm. In an embodiment, the plurality of graphene oxide membranes 108A may be arranged in a spiral wound manner. The graphene-based ultrafiltration unit 108 is configured to further remove a second portion of the one or more particulate matters and also remove a second portion of the one or more microbial matters that may be present in the seawater stream. The graphene-based ultrafiltration unit 108 is configured to produce the second filtered stream.

Further, the second filtered stream may be provided as an input to the SWRO membrane unit 110, which may utilize RO to filter the second filtered stream, thereby producing a desalinated stream and a brine stream from the second filtered stream. In an embodiment, the apparatus 102 may implement RO. In another embodiment, RO may be implemented external to the apparatus 102 but operably coupled to the apparatus 102. The controller 112 of the apparatus 102 may be configured to control an input supply of the second filtered stream to the SWRO membrane unit 110. The second filtered stream may be associated with a set of characteristics, which may be associated with at least one of a dissolved organic carbon (DOC) value, a silt density index (SDI) value, and a bio-polymer value, a turbidity value, or a modified fouling index (MFI) value.

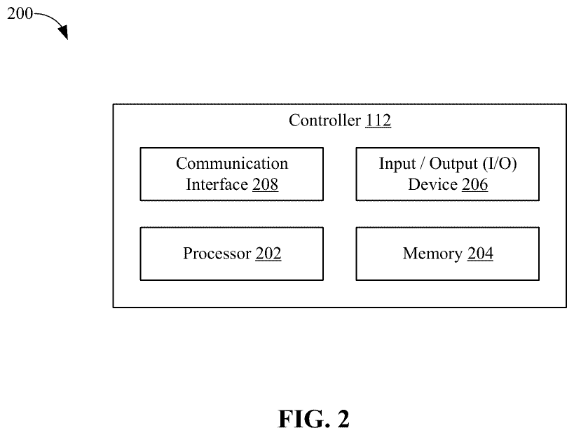

FIG. 2 illustrates a block diagram 200 depicting the controller 112 of FIG. 1, in accordance with an embodiment of the present disclosure. FIG. 2 is explained in conjunction with FIG. 1. The controller 112 may include at least one processor (referred to as a processor 202, hereinafter), at least one non-transitory memory (referred to as a memory 204, hereinafter), at least one input/output (I/O) device 206 (referred to as I/O device 206), and a communication interface 208. The processor 202 may be connected to the memory 204, the I/O device 206, and the communication interface 208 through one or more wired or wireless connections. Although in FIG. 2, it is shown that the controller 112 includes the processor 202, the memory 204, the I/O device 206, and the communication interface 208, however, the disclosure may not be so limiting and the controller 112 may include fewer or more components to perform similar or other functions of the apparatus 102. Examples of the controller 112 may include, but are not limited to, a computer workstation, a server, a smartphone, a cellular phone, a mobile phone, a consumer electronic (CE) device, or a monitoring device.

The processor 202 may be configured to perform one or more operations associated with filtration of the seawater stream. The processor 202 may be embodied as a coprocessor, a microprocessor, a controller, a digital signal processor (DSP), a processing element with or without an accompanying DSP, or other processing circuitry including integrated circuits such as, for example, an ASIC (application-specific integrated circuit), an FPGA (field programmable gate array), a microcontroller unit (MCU), a hardware accelerator, a special-purpose computer chip, or the like. In an embodiment, the processor 202 may include one or more processing cores configured to perform independently. A multi-core processor may enable multiprocessing within a single physical package. Additionally, or alternatively, the processor 202 may include one or more processors configured in tandem via a bus to enable independent execution of instructions, pipelining, or multithreading. In yet another embodiment, the processor 202 may include one or more processors that are capable of processing large volumes of workloads and operations. In an embodiment, the processor 202 may be in communication with the memory 204 via a bus for transmitting information among components of the controller 112 and apparatus 102.

In an embodiment the processor 202 may execute software instructions, which may specifically configure the processor 202 to perform algorithms or operations described herein when the software instructions are executed. However, in some cases, the processor 202 may be a processor-specific device (for example, a mobile terminal or a fixed computing device). The processor-specific device may be configured to employ an embodiment of the present disclosure by further configuring the processor 202. The processor-specific device may further configure the processor 202 by instructions for performing the algorithms and/or operations described herein. The processor 202 may include, among other things, a clock, an arithmetic logic unit (ALU), and logic gates configured to support operations of the processor 202. The communication interface 208 may provide an interface for accessing data stored in the apparatus 102. The data stored in the apparatus 102 pertains to the software instructions to be executed for implementing the features of the present disclosure.

The memory 204 may be non-transitory and may include, for example, one or more volatile or non-volatile memories. In an embodiment, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out functions, in accordance with an embodiment of the present disclosure. The memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity capable of performing operations according to the present disclosure. Thus, for example, when the processor 202 is embodied as an Application Specific Integrated Circuit (ASIC), or a Field Programmable Gate Array (FPGA), the processor 202 may be specifically configured with hardware for conducting the operations described herein.

In some example embodiments, the I/O device 206 may communicate with other components of the apparatus 102 and display the input and/or output of the apparatus 102. As such, the I/O device 206 may include one or more elements such as, but not limited to, a display, a keyboard, a mouse, a touch screen, touch areas, soft keys, one or more speakers, a ringer, one or more microphones. For example, where a rate of flow of the seawater stream or the first filtered stream or the second filtered stream needs to be controlled, the display or the keyboard or the mouse or any such component included in or associated with the I/O device 206 may be used to provide inputs to the components of the apparatus 102. In one embodiment, the apparatus 102 may include a user interface circuitry configured to control one or more functions of the I/O device 206. The processor 202 may be configured to control one or more functions of the one or more elements of the I/O device 206. The processor 202 may control the one or more functions of one or more elements of the I/O device 206 through computer program instructions stored on a memory 204 accessible to the processor 202.

The communication interface 208 may include an input interface and an output interface for supporting communications to and from the apparatus 102 or any other component(s) with which the apparatus 102 may communicate. The communication interface 208 may include any means, such as a device or a circuitry, which is embodied in either hardware or a combination of hardware and software that is configured to receive and/or transmit data to/from a communications device in communication with the apparatus 102. The communication interface 208 may include, one or more antennae and supporting hardware, or software for enabling communications with a wireless communication network. The communication interface 208 may further include a circuitry for interacting with the one or more antennae to transmit signals or to facilitate signals received via the one or more antennae. In an embodiment, the communication interface 208 may enable wired communication. The communication interface 208 may further include a communication modem or other hardware/software for supporting communication via cable, digital subscriber line (DSL), universal serial bus (USB), FireWire, Ethernet, one or more optical transmission technologies, and/or other wireline networking methods.

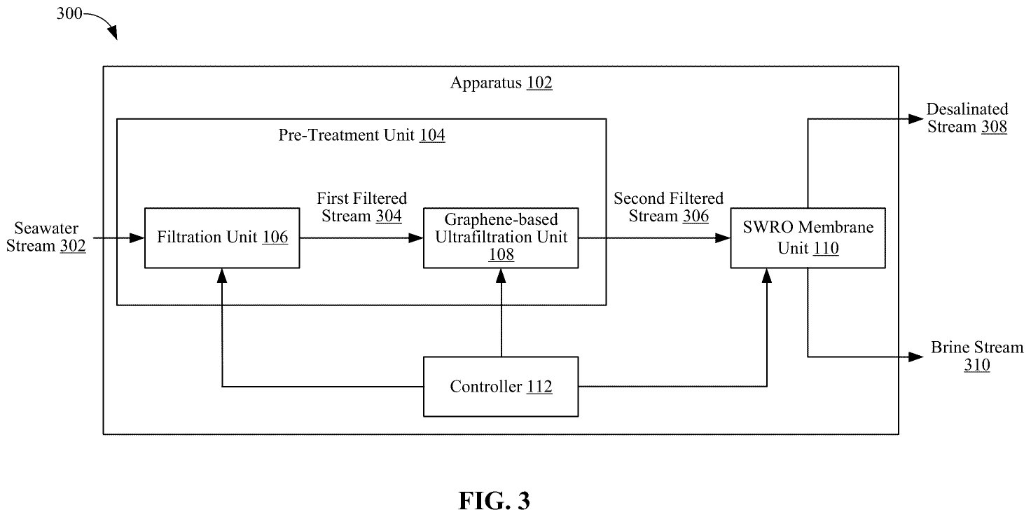

FIG. 3 is a schematic block diagram 300 illustrating one embodiment of the apparatus 102 for desalination of a seawater stream 302, in accordance with an embodiment of the disclosure. FIG. 3 is explained in conjunction with FIG. 1 and FIG. 2.

The filtration unit 106 of the pre-treatment unit 104 may be configured to receive the seawater stream 302. Specifically, the controller 112 may be configured to control a supply of the seawater stream 302 to the filtration unit 106. In an embodiment, the seawater stream 302 may be a stream of water that is directly obtained from sea or ocean. The seawater stream 302 may contain a significant concentration of dissolved substances. Also, the seawater stream 302 may include one or more particulate matters and one or more microbial matters. Examples of the one or more particulate matters present in the seawater stream 302 may include, but are not limited to, suspended particulate matter (e.g., clay, silt, dissolved salts, etc.), microplastics (such as, small plastic particles (for e.g., particles less than 5 mm in size) originating from larger plastic debris or manufactured products, etc.), and various sediments. Examples of the one or more microbial matters include, but are not limited to, bacteria (such as Pseudomonas, Vibrio, and Escherichia), viruses (such as such as bacteriophages), archaea, protozoa (such as, Amoeba and Dinoflagellates), fungi, algae, phytoplankton, zooplankton, and other organic compounds. Pollutants from various sources such as, but not limited to, industrial wastewater, municipal wastewater, leachate, frac water, oilfield produced water, etc. may get dissolved in seawater in addition to high concentration of salts and microbes present in the seawater. In an embodiment, the total dissolved salts (TDS) value of the seawater stream 302 may lie in the range of 12,000-20,000 ppm or 32,000-50,000 ppm.

In an example, rate of flow of the seawater stream 302 into the filtration unit 106 may be controlled by the controller 112. For example, the controller 112 may control the rate of flow of the seawater stream 302 into the filtration unit 106 implementing a gravity-based filtration technique so that the particles of the one or more particulate matters keep settled for the filtration. The filtration unit 106 may be configured to perform a first stage filtration on the seawater stream 302 to output a first filtered stream 304.

In an embodiment, the filtration unit 106 may include a gravity-based multimedia filtration unit, which may implement a gravity-based filtration technique utilizing force of gravity to filter the seawater stream 302. The gravity-based multimedia filtration unit may include a series of chambers or tanks that are filled with multiple filter media. The multiple filter media may be present in various layers of the gravity-based multimedia filtration unit and may include, but are not limited to, coarse filter layers, or fine filter layers. The coarse filter layers may use materials such as sand, or gravel for initial sediment removal. The fine filter layers may use materials such as, activated carbon, or ceramic for removing smaller particles and contaminants. The seawater stream 302 may flow through the multiple filter media under the force of gravity. Consequently, one or more particulate matters present in the seawater stream 302 get trapped and removed from the seawater stream 302, and the first filtered stream 304 may be collected as an output from the filtration unit 106.

In operation, the seawater stream 302 may move through the layers of the multiple filter media sequentially. For example, when the seawater stream 302 moves through the coarse filter layers of the gravity-based multimedia filtration unit, large sediment particles (i.e., particles larger than a particular threshold size) may be filtered out. Further, filtrate from the coarse filter layers moves through the fine filter layers where smaller particles (as compared to the large sediment particles) may be filtered out. Sequential transmission of the seawater stream 302 through layers of the multiple filter media in the gravity-based multimedia filtration unit results in the first filtered stream 304 as an output.

In an embodiment, the filtration unit 106 may include a pressurized multimedia-based filtration unit. The pressurized multimedia-based filtration unit may comprise a mechanical pump and a pressure filtration vessel. The mechanical pump may generate high pressure for forcing the seawater stream 302 through the pressure filtration vessel. The pressure filtration vessel may include multiple layers of filtration media. The multiple layers of filtration media of the pressurized multimedia-based filtration unit may include, but are not limited to, coarse filter layers, or fine filter layers. The coarse filter layers may use materials such as sand, or anthracite for initial sediment removal, and the fine filter layers may use materials such as, activated carbon, or ceramic for removing smaller particles and contaminants. The pressurized flow increases contact time between the liquid and the multiple layers of filtration media, improving overall filtration efficiency.

In operation, the seawater stream 302 may be pressurized and forced through multiple layers of filtration media. Contaminants may be physically retained based on size and molecular weight. Filtered liquid from the pressurized multimedia-based filtration unit that has permeated through the multiple layers of filtration media may be collected while concentrated waste may be discharged separately.

In an embodiment, the filtration unit 106 may include a membrane-based filtration unit. The membrane-based filtration unit utilizes semi-permeable membranes to separate and remove contaminants from the seawater stream 302. The semi-permeable membranes may act as barriers, allowing only the liquid to pass through while blocking contaminants including, but not limited to, suspended solids, dissolved substances, bacteria, or viruses. As the liquid is forced through the semi-permeable membrane(s) of the membrane-based filtration unit, permeate (filtered liquid) transits through pores of each of the semi-permeable membranes. Retained contaminants accumulate on surface(s) of the semi-permeable membranes, creating a concentration gradient. Process(es) implemented by the membrane-based filtration unit can be enhanced by employing techniques such as backwashing to maintain performance of the semi-permeable membrane(s), thereby increasing lifespan. The permeate is collected for use, while the retained contaminants may be discharged for further treatment. The process(es) implemented by the membrane-based filtration unit may be of different types, such as, but not limited to, nanofiltration (NF), ultrafiltration (UF), and microfiltration (MF), each associated with filtration of different sizes of contaminant molecules.

In operation, the seawater stream 302 may be forced through the semi-permeable membranes of the membrane-based filtration unit. The contaminants may be physically retained by each of the semi-permeable membranes. The first filtered stream 304 from the membrane-based filtration unit that has permeated through the semi-permeable membranes of the membrane-based filtration unit may be collected while the retained contaminants may be discharged separately.

In an embodiment, the filtration unit 106 may include one of the gravity-based multimedia filtration unit, the pressurized multimedia-based filtration unit, or the membrane-based filtration unit. In another embodiment, the filtration unit 106 may include a combination of the gravity-based multimedia filtration unit, or the pressurized multimedia-based filtration unit, or the membrane-based filtration unit to generate the first filtered stream 304. Output from the filtration unit 106, thus obtained may be referred to as the first filtered stream 304.

In an embodiment, the filtration unit 106 may include the gravity-based multimedia filtration unit followed by the pressurized multimedia-based filtration unit. Input to the filtration unit 106 may be directly provided to the gravity-based multimedia filtration unit. Output from the gravity-based multimedia filtration unit may be provided as an input to the pressurized multimedia-based filtration unit. The output of the pressurized multimedia-based filtration unit may be referred to as the first filtered stream 304.

The filtration unit 106 may remove a first portion of the one or more particulate matters and a first portion of the one or more microbial matters. In an embodiment, the filtration unit 106 may remove 90-100% of the one or more particulate matters and almost all suspended particles from the seawater stream 302. Particularly, the first portion of the one or more particulate matters corresponds to 90-100% of the one or more particulate matters. Additionally, the filtration unit 106 may remove 20-30% of one or more microbial matters (or microbial cells) from the seawater stream 302 to output the first filtered stream 304. As a result, the first portion of the one or more microbial matters corresponds to 20-30% of the one or more microbial matters. Consequently, the first filtered stream 304 has a lower amount of the one or more particulate matters as well as a lower amount of one or more microbial matters as compared to that in the seawater stream 302.

The controller 112 of the apparatus 102 may be further configured to control supply of the first filtered stream 304 to the graphene-based ultrafiltration unit 108, which may be configured to filter the first filtered stream 304 to output a second filtered stream 306. Filtration performed by the graphene-based ultrafiltration unit 108 may be a second stage pre-treatment of the seawater stream 302. The graphene-based ultrafiltration unit 108 may receive the first filtered stream 304 from the filtration unit 106.

In an embodiment, the graphene-based ultrafiltration unit 108 may include the plurality of graphene oxide membranes 108A. In an embodiment, the plurality of graphene oxide membranes 108A may be stacked adjacent to each other. Each of the plurality of graphene oxide membranes 108A may include a substrate and one or more graphene oxide layers, which may be arranged on at least one side of the substrate. In an embodiment, the substrate may include or be made of Polyvinylidene fluoride (PVDF). Further, in an embodiment, number of the one or more graphene oxide layers arranged on the substrate of a membrane of the plurality of graphene oxide membranes 108A is in a range of 40 to 60. In an embodiment, the number of graphene oxide layers may preferably be close to 50. In yet another embodiment, thickness of each of the one or more graphene oxide layers is in a range of 0.5 nanometers (nm) to 1.5 nm, and preferably close to 1 nm. The one or more graphene oxide membranes 108A may utilize properties of graphene oxide for filtration of contaminants from the first filtered stream 304. The properties of graphene oxide include, but are not limited to, high mechanical strength (50 to 150 megapascals), high adsorption efficiency for organic molecules (10-300 milligram per gram for various organic compounds), ability to introduce selective permeability to formed membranes, molecular weight cutoff (MWCO) of 300-1000 Daltons (Da), and rapid water permeation while rejecting contaminants. MWCO refers to a molecular weight at which a membrane can effectively separate molecules of contaminants from a liquid based on size of molecules of contaminants. For example, a membrane with a MWCO of 10,000 Da may allow molecules with a molecular weight less than 10,000 Da to pass through while retaining larger molecules. The plurality of graphene oxide membranes is capable of removing contaminants with MWCO larger than 300-1000 Da. For example, if the plurality of graphene oxide membranes has MWCO of 400 Da, then the plurality of graphene oxide membranes may allow contaminant molecules with a molecular weight less than 400 Da to pass through while retaining larger contaminant molecules. In an embodiment, the filtration path formed by stacked layers of graphene oxide in each of the plurality of graphene oxide membranes 108A, along with low molecular weight cutoff of 300-1000 Daltons results in rejection of contaminants such as dissolved organic carbon (DOC), viruses, bacteria, and micropollutants.

The graphene-based ultrafiltration unit 108 may remove a second portion of the one or more particulate matters and a second portion of the one or more microbial matters from the first filtered stream 304. In an embodiment, the graphene-based ultrafiltration unit 108 removes a second portion of the one or more particulate matters such that a summation of the removal of the first portion of the one or more particulate matters and the second portion of the one or more particulate matters results in a removal of 99-100% of the one or more particulate matters of the seawater stream 302. Further, the graphene-based ultrafiltration unit 108 removes a second portion of the one or more microbial matters such that a summation of the removal of the first portion of the one or more microbial matters and the second portion of the one or more microbial matters results in a removal of 96-100% of the one or more microbial matters of the seawater stream 302. As a result, the second filtered stream 306 includes less than 1% of the one or more particulate matters that were included in the seawater stream 302, and less than 4% of the one or more microbial matters that were included in the seawater stream 302.

In an embodiment, a summation of the first portion of one or more particulate matters, the first portion of one or more microbial matters, the second portion of the one or more particulate matters and the second portion of the one or more microbial matters corresponds to a first summation. Also, the one or more particulate matters and the one or more microbial matters may together be referred to as a plurality of entities. Thus, the first summation of the plurality of entities is filtered from the seawater stream 302 to produce the second filtered stream 306. Accordingly, a percentage of the total amount of the plurality of entities filtered in the second filtered stream 306 lies in a range of 98.5% to 100% as compared to the seawater stream 302. Also, each of the plurality of entities corresponds to one of the one or more particulate matters, or the one or more microbial matters.

Consequently, the second filtered stream 306 is associated with a set of characteristics, which may be associated with at least one of a dissolved organic carbon value of the second filtered stream, a silt density index (SDI) value, a bio-polymer value, a turbidity value, or a modified fouling index (MFI) value. The DOC attribute of the second filtered stream 306 refers to a fraction of organic carbon found in a dissolved state, originating from natural and anthropogenic sources, including (but not limited to) plant material, microbes, or organic waste. Higher levels of DOC may correspond to higher levels of pollution or eutrophication. The SDI value is a measure used to assess quality of water, particularly in relation to a potential of the water to cause fouling in filtration systems. The SDI quantifies concentration of suspended solids, specifically silt and fine particles, in water. The SDI is determined through a standardized test that involves moving a water sample through a filter with a specific pore size (usually 0.45 micrometers) and measuring the time it takes for a certain volume of water to pass through the filter. The bio-polymer value may refer to a value indicating an amount of naturally occurring polymers that may dissolve in water, forming a solution or gel-like consistency. The biopolymers may include, but are not limited to, polysaccharides, proteins, and nucleic acids, and may be derived from biological sources, such as plants, animals, or microorganisms, and play various roles in biological systems and industrial applications. The turbidity value of the second filtered stream 306 refers to clarity of the second filtered stream 306. Higher turbidity may correspond to higher levels of suspended particles, such as sediments, organic matter, or microorganisms in the second filtered stream 306. The MFI value of the second filtered stream 306 refers to a parameter used to evaluate fouling potential of membranes in water purification when the second filtered stream 306 is provided to the membranes as input. The MFI value indicates how easily a membrane can become fouled by various substances present in the water.

In an embodiment, the bio-polymer removal value of the second filtered stream 306 is in the range of 65-100%. The bio-polymer removal value of the second filtered stream 306 refers to an extent of removal of the biopolymers from the seawater stream 302 to output the second filtered stream 306. Accordingly, the bio-polymer removal value in the range of 65-100% indicates that 65-100% of the biopolymers have been removed in the second filtered stream 306 as compared to the seawater stream 302.

In an embodiment, the DOC attribute corresponds to a dissolved organic carbon (DOC) removal value of the second filtered stream 306. The DOC removal value of the second filtered stream 306 is in the range of 35-100%. The DOC removal value of the second filtered stream 306 refers to an extent of removal of the DOC from the seawater stream 302 to output the second filtered stream 306. Accordingly, the DOC removal value in the range of 35-100% indicates that 35-100% of the DOC has been removed in the second filtered stream 306 as compared to the seawater stream 302.

In an embodiment, the SDI value of the second filtered stream 306 is in the range of 0 to 1.

In an embodiment, the turbidity value of the second filtered stream is in a range of 0 to 0.5 nephelometric turbidity units (NTU).

In an embodiment, the MFI value of the second filtered stream is in a range of 0 to 0.5.

In an embodiment, the apparatus 102 may be further configured to control the supply of the second filtered stream 306 to the SWRO membrane unit 110 to obtain a desalinated stream 308 and a brine stream 310 from the second filtered stream 306. Specifically, the controller 112 may be configured to control the supply of the second filtered stream 306 to the SWRO membrane unit 110. The SWRO membrane unit 110 may comprise one or more membrane layers 110A, which may be semi-permeable membranes. The desalinated stream 308 may refer to the filtered liquid that transits through the one or more membrane layers 110A. Further, the brine stream 310 may refer to a concentrate, which contains rejected contaminants and does not transit through the one or more membrane layers 110A. The apparatus 102 may further be configured to store the desalinated stream 308 for downstream tasks such as usage or distribution. In yet another embodiment, the apparatus 102 may further be configured to store the brine stream 310 for further treatment. Alternatively, the apparatus 102 may be configured to discharge the brine stream 310. The discharge of the brine stream 310 may include discharging in systems such as, but not limited to, drains, sewage systems, rivers, or oceans. The discharge of the brine stream 310 may further include storage for treatment before discharge, or consumption in other tasks, where other tasks include the tasks in which the desalinated stream 308 is not generally consumed.

Pertinently, the seawater stream 302, the first filtered stream 304 and the second filtered stream 306 are independent of each chemical agent from a set of pre-treatment chemical agents. Therefore, the brine stream 310 produced by the SWRO membrane unit 110 does not contain the set of pre-treatment chemical agents that are conventionally used for pre-treatment of the seawater stream 302. Consequently, a need to chemically treat the brine stream 310 for the effluent discharge is eliminated, thereby reducing energy efficiency. The set of pre-treatment chemical agents may include at least one of ferric chloride, sodium hypochlorite, chlorine dioxide, or sulphuric acid. The pre-treatment chemical agents may include disinfectants, coagulants, or acids. Examples of disinfectants may include, but are not limited to, sodium hypochlorite, or chlorine dioxide. Examples of coagulants may include, but are not limited to, ferric chloride. Examples of acids may include, but are not limited to, sulfuric acid. Also, there is no usage of such pre-treatment chemical agents in any operation of the sweater desalination process according to the present disclosure. Thus, in an embodiment, the seawater stream 302, the first filtered stream 304 and the second filtered stream 306 are independent of each chemical agent from the set of pre-treatment chemical agents.

The SWRO membrane unit 110 may use the one or more membrane layers 110A to remove contaminants in the second filtered stream 306. In an embodiment, the SWRO membrane unit 110 may be a component of a filtration device such as, but not limited to, a reverse osmosis (RO) system, a nanofiltration system, a forward osmosis system, or a combination thereof. The filtration device that includes the SWRO membrane unit 110 may receive the second filtered stream 306 as input, and output a desalinated stream 308 and a brine stream 310 after filtering the second filtered stream 306.

In an embodiment of the present disclosure, the apparatus 102 includes the filtration device that includes the SWRO membrane unit 110. In another embodiment, the filtration device is separate from the apparatus 102, but the filtration device is configured to receive the second filtered stream 306 from the apparatus 102 as input.

In yet another embodiment, an RO system of the filtration device may include the SWRO membrane unit 110 to remove impurities from the second filtered stream 306. The RO system may cause application of pressure to the second filtered stream 306, causing the second filtered stream 306 to move through the SWRO membrane unit 110 of the RO system. Consequently, the desalinated stream 308 (i.e., the permeate of the SWRO membrane unit 110) may be collected while the brine stream 310 containing contaminants may be received as an output separately.

A variation of the RO system to be implemented is based on an application. For example, in industrial settings, large-scale RO systems (e.g., a SWRO plant) may be used for desalination. The SWRO plant may include multiple membrane units. The SWRO plant may be a desalination plant that may use a process of RO to convert seawater into freshwater. The process may involve forcing seawater through the membranes (of the RO system) that may only allow water molecules to pass through while filtering out contaminants, such as salt and impurities. In the field of residential water purification, a popular example is an under-sink RO system. The under-sink RO system is installed under a kitchen sink and provides purified drinking water directly from a dedicated faucet. Further, freshwater received as an output from the under-sink RO system may then be stored, and ready for distribution.

In another example, the filtration device may include a nanofiltration system. The nanofiltration system may be a variation of RO that uses slightly lower pressure and can selectively remove certain solutes based on size and charge. For example, pore sizes of the semi-permeable membranes used in the nanofiltration system may range from 1 to 10 nanometers.

In another example, the filtration device may include a forward osmosis system. The forward osmosis system may use natural osmotic pressure to induce flow of second filtered stream 306 through the semi-permeable membrane(s), leaving behind the contaminants (or impurities). In the forward osmosis system, the second filtered stream 306 is placed on one side of the semi-permeable membrane(s), while a draw solution (that is a concentrated solution of a solute like sodium chloride, etc.) is received as an output from the semi-permeable membrane. The second filtered stream 306 naturally flows towards the draw solution through the semi-permeable membrane(s), due to a difference in osmotic pressure. As a result, the draw solution is diluted, which is further separated from the second filtered stream 306 to output the desalinated stream 308 and the brine stream 310.

The second filtered stream 306, which is received as an out from the graphene-based ultrafiltration unit 108, is further provided as an input to the SWRO membrane unit 110. Pertinently, 99%-100% of the one or more particulate matters and 96%-100% of the one or more microbial matters that were present in the seawater stream 302 are removed, and are not present in the second filtered stream 306. The one or more particulate matters and the one or more microbial matters are prominent sources of membrane fouling (including, but not limited to, biofouling, particulate fouling, or organic fouling) of the one or more membranes layers 110A of the SWRO membrane unit 110. In an embodiment, the second filtered stream 306 is free from the first portion and the second portion of the one or more particulate matters and the first portion and the second portion of the one or more microbial matters, such that the desalinated stream 308 based on the second filtered stream 306 prevents accumulation of the one or more entities on the one or more membrane layers 110A in the SWRO membrane unit 110. The one or more entities may refer to the particles of the one or more particulate matters and particles of the one or more microbial matters, that may accumulate on the one or more membranes layers 110A of the SWRO membrane unit 110 and block pores of the one or more membranes layers 110A, resulting in membrane fouling of the one or more membranes layers 110A. Thus, the membrane fouling of the one or more membranes layers 110A of the SWRO membrane unit 110 is prevented as the second filtered stream 306 (instead of the seawater stream 302) is provided as input to the SWRO membrane unit 110.

The supply of the second filtered stream 306 to the SWRO membrane unit 110 causes an accumulation of a first quantity of the one or more entities over a predefined time period on one or more membrane layers 110A in the SWRO membrane unit 110. The first quantity is less than a fouling threshold. The fouling threshold of a membrane refers to an amount of foulants (such as particles, organic matter, or biological growth), such that an accumulation of the foulants beyond the amount on a surface(s) or within pores of one or more membrane(s) begins to significantly impair performance of the one or more membrane(s). In an embodiment, the fouling threshold may correspond to the amount at which servicing of the membrane layers 110A may become pertinent. In another embodiment, the fouling threshold may correspond to the amount at which replacement of the membrane layers 110A may become pertinent.

For example, providing the seawater stream 302 to the SWRO membrane unit 110 directly leads to accumulation of first quantity of the one or more entities in a predefined time period of say, X days, that causes membrane fouling to an extent that the membrane needs to be serviced or replaced after X days. That is, the membrane fouling reaches the fouling threshold for servicing after X days. In such a case, the SWRO membrane unit 110 may need to be serviced after every X days due to membrane fouling, which will incur a servicing cost. Providing the second filtered stream 306 to the SWRO membrane unit 110 leads to an accumulation of the first quantity of the one or more entities in a pre-defined time period of say, Y days, where the value of Y is greater than the value of X.

In an example, the membrane fouling of the membrane layers 110A occurs to an extent that the SWRO membrane unit 110 needs to be serviced occurs after Y days. That is, the membrane fouling reaches the fouling threshold after Y days. Since the time duration of the membrane fouling reaching the fouling threshold has increased from X to Y, the same cost of servicing the SWRO membrane unit 110 would be incurred after longer time duration, which will lead to cost effectiveness over a lifespan of the membrane layers 110A. It may be noted that the first quantity refers to an amount of particles or entities that get accumulated at the SWRO membrane unit 110 until the predefined time period is reached. For example, the supply of the second filtered stream 306 to the membrane layers 110A for a time period T causes accumulation of quantity X of the one or more entities at the membrane layers 110A. Further, the supply of the seawater stream 302 to the membrane layers 110A for the time period T causes accumulation of quantity Y of the one or more entities at the membrane layers 110A, where the quantity Y is greater than the quantity X. Since the quantity Y is greater than the quantity X, the fouling of the membrane layers 110A caused by the quantity Y is greater than the fouling of the membrane layers 110A caused by the quantity X. Thus, the supply of the second filtered stream 306 to the membrane layers 110A results in reduced fouling of the membrane layers 110A in a specific time period as compared to the fouling of the membrane layers 110A caused by a direct supply of seawater stream 302 to the membrane layers 110A for the specific time period. In an embodiment, the fouling threshold may be a threshold quantity of accumulation of the one or more entities after which replacement of the membrane layers 110A may become pertinent. In another embodiment, the fouling threshold may be a threshold quantity of accumulation of the one or more entities after which servicing of the membrane layers 110A may become pertinent.

As an objective of the present disclosure, the first quantity of the one or more entities accumulated at the SWRO membrane unit 110 is less than a fouling threshold of the SWRO membrane unit 110. As the fouling threshold is not reached within the predefined time period, the SWRO membrane unit 110 may not need be replaced or serviced. In addition, less deposition of the one or more entities on the membrane layers 110A of the SWRO membrane unit 110 will further lead to reduction in energy consumption for pumping water through the SWRO membrane unit 110. The reduction in energy consumption for pumping water through the SWRO membrane unit 110 will further lead to reduction in costs as well as reduction in specific energy consumption (SEC) value for the output of desalinated stream 308.

In another embodiment, providing the seawater stream 302 to the SWRO membrane unit 110 directly leads to accumulation of a first quantity of the one or more entities in a time period, T₁ day(s), that causes membrane fouling to an extent that the membrane needs to be replaced substantially after the T₁ days. A periodic replacement of the one or more membrane(s) every T₁ days due to membrane fouling may incur replacement costs. Providing the second filtered stream 306 to the SWRO membrane unit 110 leads to accumulation of the first quantity of the one or more entities in a time period, T₂ days, where a value of T₂ is greater than a value of T₁. The membrane fouling reaches the fouling threshold after T₂ days. As a result, time required for the one or more membrane(s) to reach the fouling threshold for replacement of the membrane layers 110A has increased from T₁ to T₂. Consequently, a similar cost of replacement of the SWRO membrane unit 110 or the membrane layers 110A of the SWRO membrane unit 110 would be incurred after longer time duration, which will lead to overall cost effectiveness.

Reduction of membrane fouling of the one or more membranes of the SWRO membrane unit 110 reduces overall cost of filtration of the seawater stream 302 as a frequency of replacing the one or more membrane(s), and a frequency of servicing the one or more membrane(s) are reduced. Also, the reduction of membrane fouling of the one or more membrane(s) of the SWRO membrane unit 110 results in an increased rate of flow of water through the one or more membrane(s), which further decreases energy consumption for filtration of the seawater stream 302. Further, techniques, as described in the present disclosure, eliminate use of cartridge filter(s) which are traditionally used in existing technologies before the one or more membrane(s) of the filtration systems.

The graphene-based ultrafiltration unit 108 and the filtration unit 106 do not implement chemical treatment of the seawater stream 302 at any stage of filtration. Thus, there is no introduction of any chemical, such as (but not limited to) Ferric Chloride, Sodium Hypochlorite or Chlorine dioxide that were used in existing technologies. Use of chemicals, for example Sodium Hypochlorite, may degrade the one or more membranes of the SWRO membrane unit 110, and may result in membrane fouling of the one or more membranes of the SWRO membrane unit 110. Further, membrane fouling of the one or more membranes of the SWRO membrane unit 110 due to Sodium Hypochlorite may be quenched using other chemicals such as Sodium Bisulfite, which adds further costs. Also, since chemical agents to pre-treat the seawater stream 302 are not introduced in the second filtered stream 306, the brine stream 310 does not contain pre-treatment chemical agents. Thus, the brine stream 310 may not require treatment of the pre-treatment chemical agents before being discharged into water bodies directly or through drains, or sewage systems. Thus, absence of the pre-treatment chemical agents in the brine stream 310 further reduces overall costs associated with filtration of the seawater stream as compared to the traditional systems.

Moreover, the apparatus 102 for controlling pre-treatment of the seawater stream 302 eliminates a requirement to construct large and expensive water treatment systems, such as dissolved air flotation (DAF) systems, thereby saving capital costs and enhancing efficiency and ease of implementation.

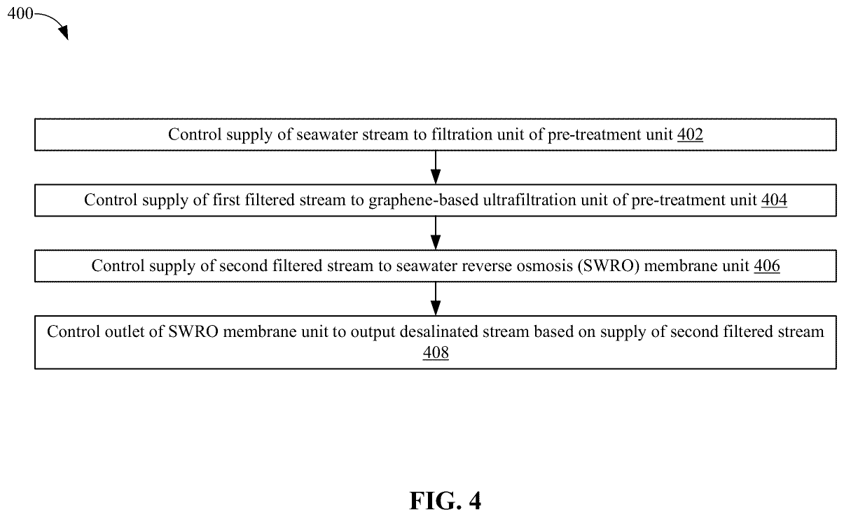

FIG. 4 illustrates an exemplary flowchart 400 of a method for controlling filtration of a seawater stream, in accordance with an embodiment of the disclosure. FIG. 4 is explained in conjunction with elements from FIG. 1, FIG. 2, and FIG. 3. Operations of the exemplary flowchart 400 may be executed by any computing system, for example, by the controller 112 of FIG. 1 or the processor 202 of FIG. 2. The operations of the flowchart 400 may start at 402.

At 402, a supply of the seawater stream 302 to the filtration unit 106 is controlled. The filtration unit 106 may be configured to output a first filtered stream 304 based on the supply of the seawater stream 302. In an embodiment, the controller 112 or the processor 202 is configured to control the supply of the seawater stream 302 to the filtration unit 106. The seawater stream 302 may include the one or more particulate matters and the one or more microbial matters. In an embodiment, the filtration unit 106 may include one of the gravity-based multimedia filtration unit, the pressurized multimedia-based filtration unit, or the membrane-based filtration unit. In another embodiment, the filtration unit 106 may include a combination of the gravity-based multimedia filtration unit, the pressurized multimedia-based filtration unit, or the membrane-based filtration unit to generate the first filtered stream 304. A final output from the filtration unit 106, that is, from the one of the gravity-based multimedia filtration unit, the pressurized multimedia-based filtration unit, or the membrane-based filtration unit, or the combination thereof, may be referred to as the first filtered stream 304. Also, the filtration unit 106 may remove a first portion of the one or more particulate matters and a first portion of the one or more microbial matters. The first portion of the one or more particulate matters corresponds to 90-100% of the one or more particulate matters. Additionally, the filtration unit 106 may remove 20-30% of one or more microbial matters. The first portion of the one or more microbial matters corresponds to 20-30% of the one or more microbial matters.

At 404, a supply of the first filtered stream 304 to the graphene-based ultrafiltration unit 108 is controlled. In an embodiment, the controller 112 or the processor 202 is configured to control the supply of the first filtered stream 304 to the graphene-based ultrafiltration unit 108. The graphene-based ultrafiltration unit 108 is configured to output the second filtered stream 306 based on the supply of the first filtered stream 304. The graphene-based ultrafiltration unit 108 may include one or more graphene oxide membranes 108A that may be arranged in a spiral wound manner. The graphene-based ultrafiltration unit 108 may utilize properties of graphene oxide for filtration of contaminants from the first filtered stream 304. The graphene-based ultrafiltration unit 108 may remove a second portion of the one or more particulate matters and a second portion of the one or more microbial matters from the first filtered stream 304. In an embodiment, the graphene-based ultrafiltration unit 108 removes 99-100% of the one or more particulate matters of the seawater stream 302 and 96-100% of the one or more microbial matters of the seawater stream 302. Consequently, the second filtered stream 306 is associated with a set of characteristics. The set of characteristics may be associated with at least one of a dissolved organic carbon value of the second filtered stream, a silt density index (SDI) value of the second filtered stream, a bio-polymer value of the second filtered stream, a turbidity value of the second filtered stream, or a modified fouling index (MFI) value of the second filtered stream, which are explained above in the present disclosure and are not repeated here for the sake of brevity.

At 406, a supply of the second filtered stream to the SWRO membrane unit 110 is controlled. In an embodiment, the controller 112 or the processor 202 is configured to control the supply of the second filtered stream 306 to the SWRO membrane unit 110. The SWRO membrane unit 110 may use one or more membrane layers 110A to remove contaminants in the second filtered stream 306. The one or more membrane layers 110A may correspond to a set of one or more semi-permeable membranes.

At 408, the outlet of the SWRO membrane unit 110 is controlled to output the desalinated stream 308 based on the supply of the second filtered stream 306. In an embodiment, the controller 112 or the processor 202 may be configured to store the desalinated stream 308 for downstream tasks such as usage or distribution. In yet another embodiment, the apparatus 102 may further be configured to store the brine stream 310 for further treatment of the brine stream 310. Pertinently, the brine stream 310 produced by the SWRO membrane unit 110 does not contain chemicals that were used for pre-treatment of the seawater stream 302 using the traditional techniques. Consequently, the method as described by flowchart 400 reduces a need for chemical treatment of the brine stream 310 for effluent discharge.

Accordingly, blocks of the flowchart 400 support combinations of means for performing specified functions and combinations of operations for performing the specified functions. It will also be understood that one or more blocks of the flowchart 400 or combinations of blocks in the flowchart 400 can be implemented by special purpose hardware-based computer system which perform the specified functions, or combinations of special purpose hardware and computer instructions.

Alternatively, the controller 112 may comprise means for performing each of the operations described above. According to an embodiment, means for performing operations may comprise, for example, the controller 112, the processor 202 or a device/circuit for executing instructions or executing an algorithm for processing information, as described above.

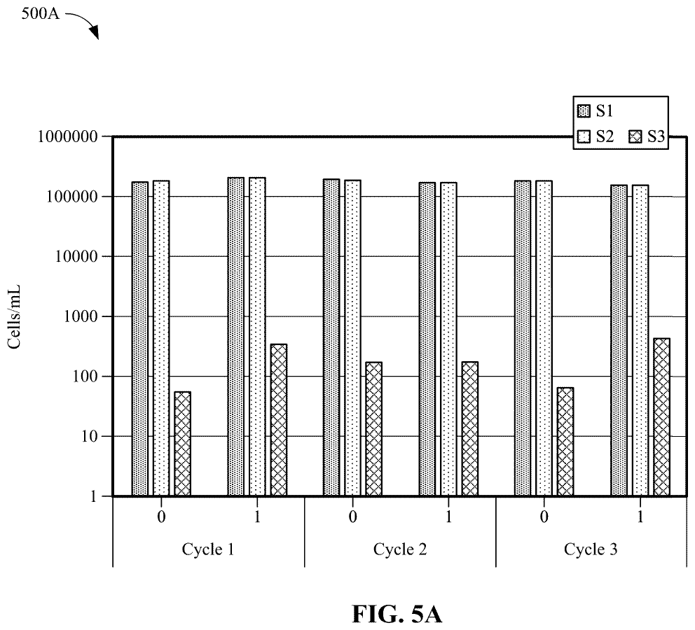

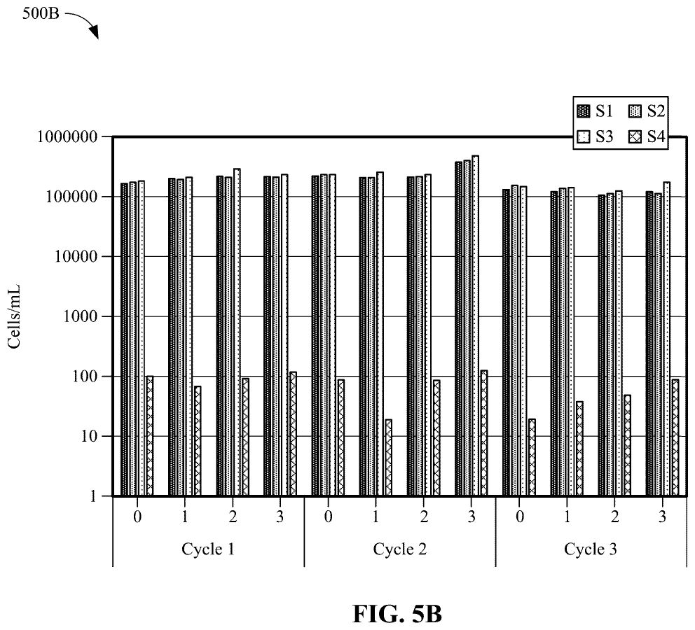

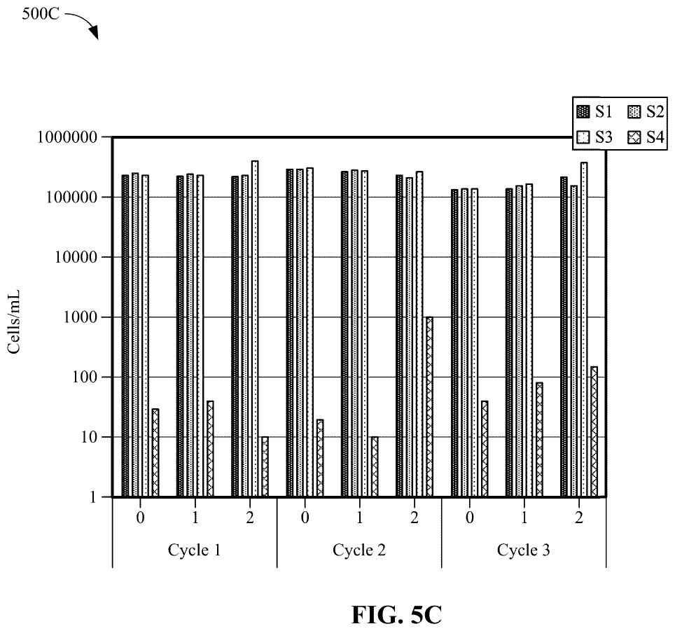

FIG. 5A illustrates a chart 500A, which describes first experimental data related to reduction in microbial matters, in accordance with an embodiment of the present disclosure. The chart 500A shows reduction of the one or more microbial matters by the graphene-based ultrafiltration unit 108 when seawater is provided as input to the graphene-based ultrafiltration unit 108. In the chart 500A, S1 refers to the seawater such as the seawater stream 302, S2 refers to the output retentate of the graphene-based ultrafiltration unit 108, and S3 refers to the output permeate of the graphene-based ultrafiltration unit 108. Further, the term “cycle”, in general, refers to an instance of cleaning the membrane(s) of the graphene-based ultrafiltration unit 108. The cleaning of the membrane(s) is performed at an instance when the one or more particulate matters and/or the one or more microbial matters get deposited/accumulated to an extent of threshold limit. The threshold limit is the limit of accumulation of the one or more particulate matters and/or the one or more microbial matters that may be allowed for proper filtration of water through the membrane(s). For example, a fresh and clean membrane(s) is/are implemented in the graphene-based ultrafiltration unit 108 at the start of a cycle. After a few rounds of cleaning the input water that is provided to the graphene-based ultrafiltration unit 108, the membrane(s) get fouled to an extent that the membrane(s) need to be cleaned. At an instant, when the membrane(s) get fouled to an extent that the membrane(s) need to be cleaned is indicative of completion of the cycle. A new cycle starts subsequently on cleaning the membrane(s). Thus, the terms cycle 1, cycle 2, and cycle 3 of FIG. 5A refer to the instances of cleaning the membrane(s) of the graphene-based ultrafiltration unit 108. Further, the values 0, 1, 2, or 3 refer to rounds of water treatment by the membrane(s) of a graphene-based ultrafiltration unit such as, the graphene-based ultrafiltration unit 108, before the membrane(s) of the graphene-based ultrafiltration unit are cleaned. Thus, the values 0 and 1 for each cycle in FIG. 5A refer to the rounds of seawater treatment before the cleaning of the membrane(s) of the graphene-based ultrafiltration unit 108. As shown in the chart 500A, a quantity of the one or more microbial matters in the S1 and the S2 is above 1,00,000 cells per milliliter (mL), while a quantity of the one or more microbial matters in the S3 is below 100 cells per mL in round 0 of cycle 1. Further, the quantity of the one or more microbial matters in the S3 is in a range of 100 to 1000 cells per mL in round 1 of cycle 1. Similarly, the quantity of the one or more microbial matters in the S1 and the S2 is above 1,00,000 cells per mL for cycle 2 and cycle 3, while the quantity of the one or more microbial matters in the S3 is in a range of 50 to 1000 cells per mL in cycle 2 and cycle 3. Particularly, the graphene-based ultrafiltration unit 108 cleans more than 99% of the one or more microbial matters from the seawater.

FIG. 5B illustrates a chart 500B, which describes second experimental data related to reduction in microbial matters, in accordance with an embodiment of the present disclosure. The chart 500B of FIG. 5B shows reduction of the one or more microbial matters by the graphene-based ultrafiltration unit 108 when a filtered stream such as, the first filtered stream 304, is provided as input to the graphene-based ultrafiltration unit 108 at a first rate of flow and a first pressure value. In an embodiment of the disclosure, the first filtered stream 304 is stored in a reservoir before being provided to the graphene-based ultrafiltration unit 108. Thus, in the chart 500B, S1 refers to a filtered stream output from the filtration unit 106. For example, the filtered stream output from the filtration unit 106 may be the first filtered stream 304. Further, in the chart 500B, S2 refers to the stream that is provided as input to the graphene-based ultrafiltration unit 108 from the reservoir. Thus, the S1 after being stored in the reservoir is referred to as S2. Pertinently, the S2 may contain a greater amount of the one or more microbial matters as compared to the amount of the one or more microbial matters contained in the S1, as the one or more microbial matters may further develop in the S2 when the water is stored in the reservoir. Further, in the chart 500B, S3 refers to the output retentate of the graphene-based ultrafiltration unit 108, and S4 refers to the output permeate of the graphene-based ultrafiltration unit 108. As shown in chart 500B, the quantity of the one or more microbial matters in the S1, the S2, and the S3 is above 1,00,000 cells per mL in cycle 1, cycle 2, and cycle 3. Further, the quantity of the one or more microbial matters in the S4 is either below 100 cells per mL or approximately 100 but less than 500 cells per mL in cycle 1, cycle 2, and cycle 3. Notably, since the input to the graphene-based ultrafiltration unit 108 is the S1 or the S2 and not the seawater, therefore number of rounds in each cycle that were possible has also increased from 2 rounds (i.e., round 0 and round 1) as shown in FIG. 5A to 4 rounds (round 0, round 1, round 2, and round 3) as shown in FIG. 5B.

FIG. 5C illustrates a chart 500C, which describes third experimental data related to reduction in microbial matters, in accordance with an embodiment of the present disclosure. The chart 500C of FIG. 5C shows reduction of the one or more microbial matters by the graphene-based ultrafiltration unit 108 when a filtered stream such as, the first filtered stream 304, is provided as input to the graphene-based ultrafiltration unit 108 at a second rate of flow and a second pressure value. As can be seen from FIG. 5A, FIG. 5B, and FIG. 5C, the fouling of the membrane(s) of the graphene-based ultrafiltration unit 108 is significantly reduced when the filtered stream is provided to the graphene-based ultrafiltration unit 108 as compared to when seawater is directly provided to the graphene-based ultrafiltration unit 108.

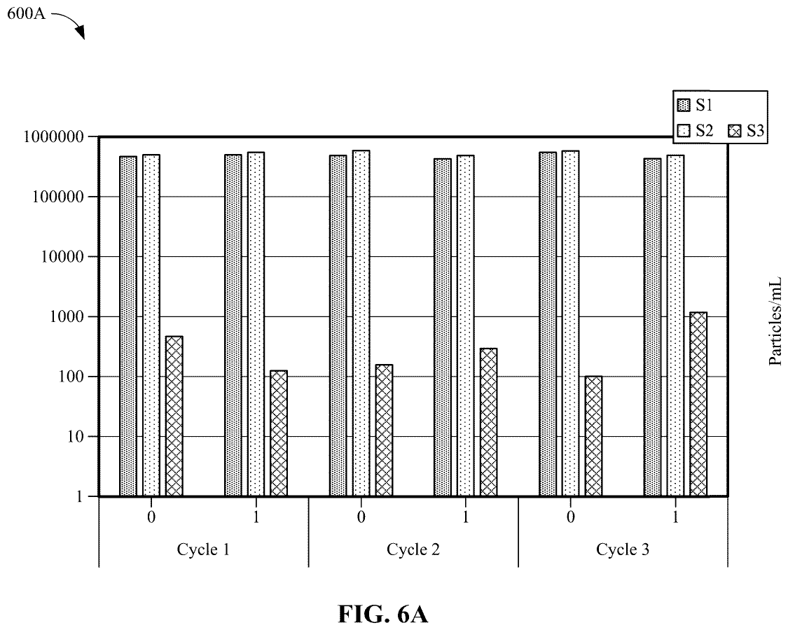

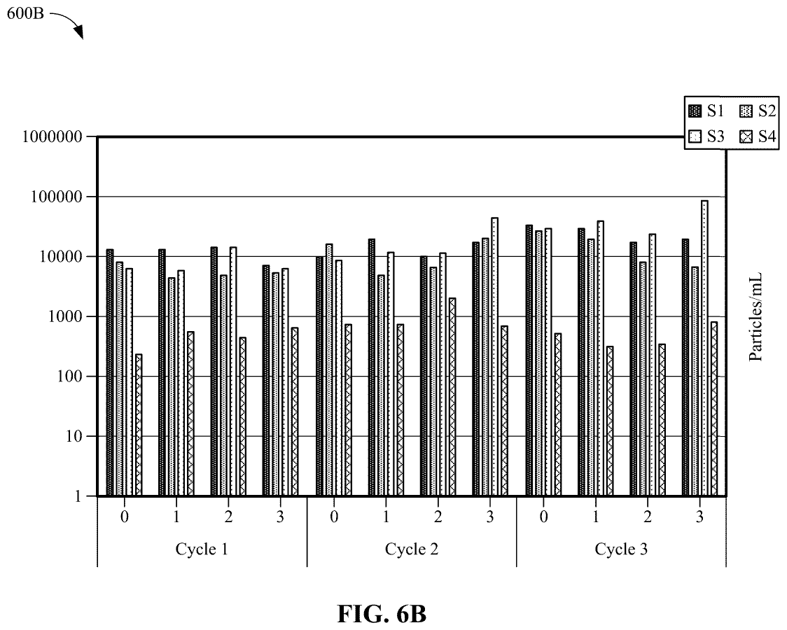

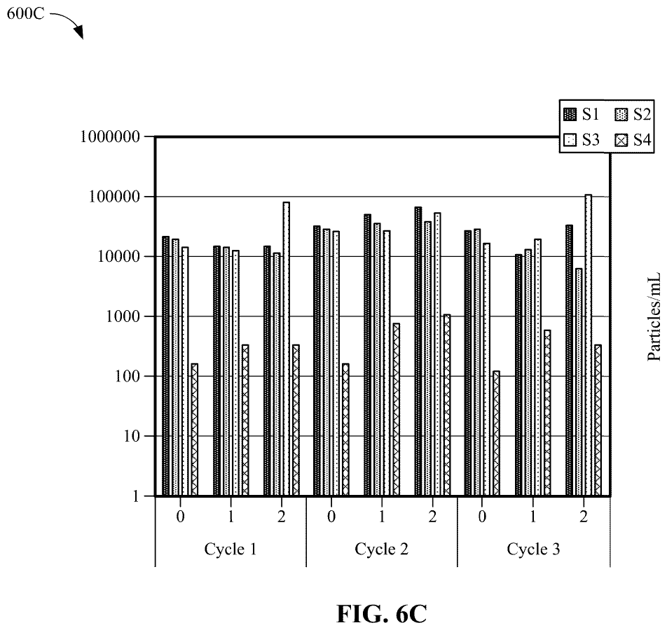

FIG. 6A illustrates a chart 600A, which describes first experimental data related to reduction in particulate matters of size 0.5-20 micrometers, in accordance with an embodiment of the present disclosure. The chart 600A shows reduction of the one or more particulate matters by the graphene-based ultrafiltration unit 108 when seawater is provided as input to the graphene-based ultrafiltration unit 108. In the chart 600A, S1 refers to the seawater such as the seawater stream 302, S2 refers to the output retentate of the graphene-based ultrafiltration unit 108, and S3 refers to the output permeate of the graphene-based ultrafiltration unit 108. Further, as noted above, the term cycle, in general, refers to an instance of cleaning the membrane(s) of the graphene-based ultrafiltration unit 108 when due to accumulation of the one or more particulate matters and/or the one or more microbial matters, the membrane(s) of the graphene-based ultrafiltration unit 108 need to be cleaned. Thus, the terms cycle 1, cycle 2, and cycle 3 of FIG. 6A refer to the instances of cleaning the membrane(s) of the graphene-based ultrafiltration unit 108. Particularly, the terms cycle 1, cycle 2, and cycle 3 refer to the cleaning of the membrane(s) that is performed when the one or more particulate matters or the one or more microbial matters get deposited/accumulated to an extent of threshold limit, as explained above in the present disclosure. Further, as noted above, the values 0, 1, 2, or 3 refer to rounds of water treatment by the membrane(s) of a graphene-based ultrafiltration unit such as, the graphene-based ultrafiltration unit 108, before the membrane(s) of the graphene-based ultrafiltration unit are cleaned. Thus, the values 0 and 1 for each cycle in FIG. 6A refer to the rounds of seawater treatment before the cleaning of the membrane(s) of the graphene-based ultrafiltration unit 108. As shown, the quantity of the one or more particulate matters in the S1 and the S2 is above 1,00,000 particles per mL, while the quantity of the one or more particulate matters in the S3 is in range of 100-1000 particles per mL in each cycle as shown in 600A. Further, the quantity of the one or more microbial matters in the S3 is in a range of 100 to 1000 particles per mL in each cycle of 600A. Particularly, the graphene-based ultrafiltration unit 108 cleans more than 99% of the one or more particulate matters from the water stream that is input to the graphene-based ultrafiltration unit 108.

FIG. 6B illustrates a chart 600B, which describes second experimental data related to reduction in particulate matters of size 0.5-20 micrometers, in accordance with an embodiment of the present disclosure. The chart 600B of FIG. 6B shows reduction of the one or more particulate matters by the graphene-based ultrafiltration unit 108 when a filtered stream such as, the first filtered stream 304, is provided as input to the graphene-based ultrafiltration unit 108 at a first rate of flow and a first pressure value. In an embodiment of the disclosure, the first filtered stream 304 is stored in a reservoir before being provided to the graphene-based ultrafiltration unit 108. Thus, in the chart 600B, S1 refers to the filtered stream output from the filtration unit 106. Further, in the chart 600B, S2 refers to the stream that is provided as input to the graphene-based ultrafiltration unit 108 from the reservoir. Pertinently, the S2 may contain a greater amount of the one or more microbial matters as compared to the amount of the one or more microbial matters contained in the S1. Further, in the chart 600B, S3 refers to the output retentate of the graphene-based ultrafiltration unit 108, and S4 refers to the output permeate of the graphene-based ultrafiltration unit 108. As shown in chart 600B, the quantity of the one or more particulate matters in the S1, the S2, and the S3 is in a range of 5000-50000 particles per mL in each cycle as shown in the chart 600B. Further, the quantity of the one or more particulate matters in the S4 is in a range of 100-1000 particles per mL as shown in the chart 600B. Notably, since the input to the graphene-based ultrafiltration unit 108 is the S1 or the S2 and not the seawater, the number of rounds in each cycle that were possible would also increase from 2 rounds (i.e., round 0 and round 1) as shown in FIG. 6A to 4 rounds (round 0, round 1, round 2, and round 3) as shown in FIG. 6B.

FIG. 6C illustrates a chart 600C, which describes third experimental data related to reduction in particulate matters of size 0.5-20 micrometers, in accordance with an embodiment of the present disclosure. The chart 600C shows reduction of the one or more particulate matters by the graphene-based ultrafiltration unit 108 when a filtered stream such as, the first filtered stream 304, is provided as input to the graphene-based ultrafiltration unit 108 at a second rate of flow and a second pressure value. As can be seen in FIG. 6A, FIG. 6B, and FIG. 6C that the fouling of the membrane(s) of the graphene-based ultrafiltration unit 108 is significantly reduced when the filtered stream is provided to the graphene-based ultrafiltration unit 108 as compared to the case where seawater is directly provided to the graphene-based ultrafiltration unit 108.

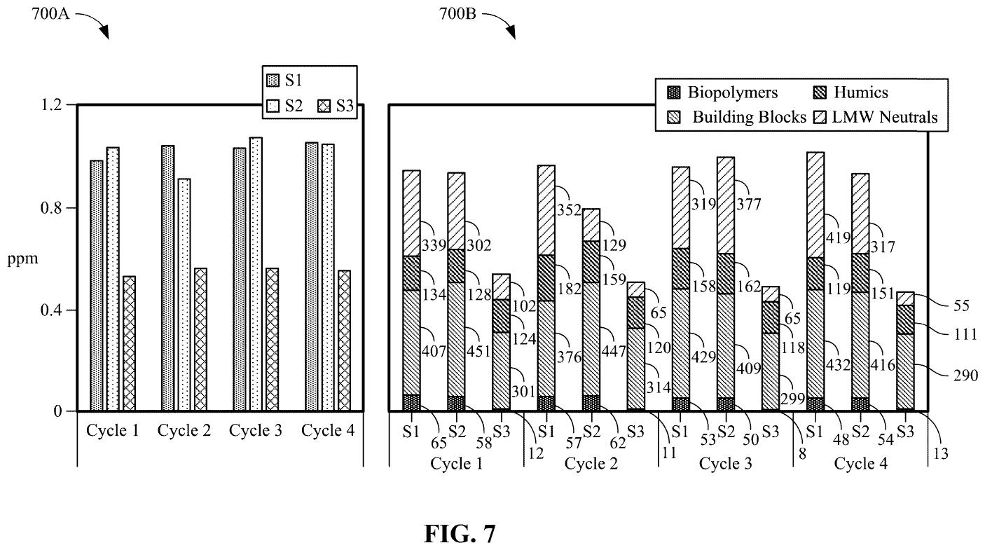

FIG. 7 illustrates a chart 700A and a chart 700B, which describe experimental data related to removal of dissolved organic carbon (DOC) by graphene-based ultrafiltration unit, in accordance with an embodiment of the present disclosure. The chart 700A illustrates the DOC removal by the graphene-based ultrafiltration unit 108 when seawater, such as the seawater stream 302 is input to the graphene-based ultrafiltration unit 108. In the charts 700A and 700B, S1 refers to the seawater such as the seawater stream 302, S2 refers to the output retentate of the graphene-based ultrafiltration unit 108, and S3 refers to the output permeate of the graphene-based ultrafiltration unit 108. As shown, the DOC values of the S1 and the S2 are above 1.0 for each cycle of the chart 700A. Further, the DOC value of the S3 is approximately 0.5 for each cycle of the chart 700A. The chart 700B illustrates fractions of each of the biopolymers, humics, building blocks, and low molecular weight (LMW) neutrals in each of the S1, the S2, and the S3. The fractions of each of the biopolymers, the humics, the building blocks, and the LMW neutrals in the S3 are significantly reduced as compared to the respective values in the S1 and the S2 in the chart 700B.

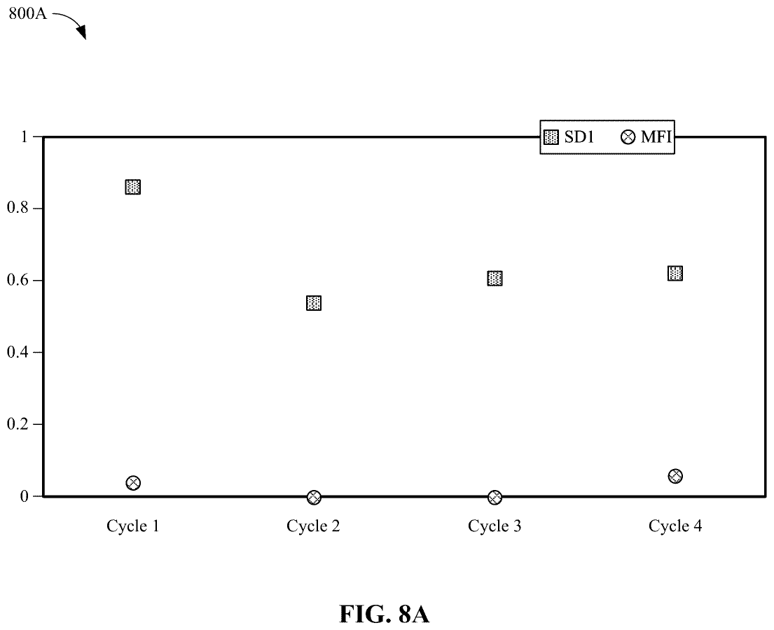

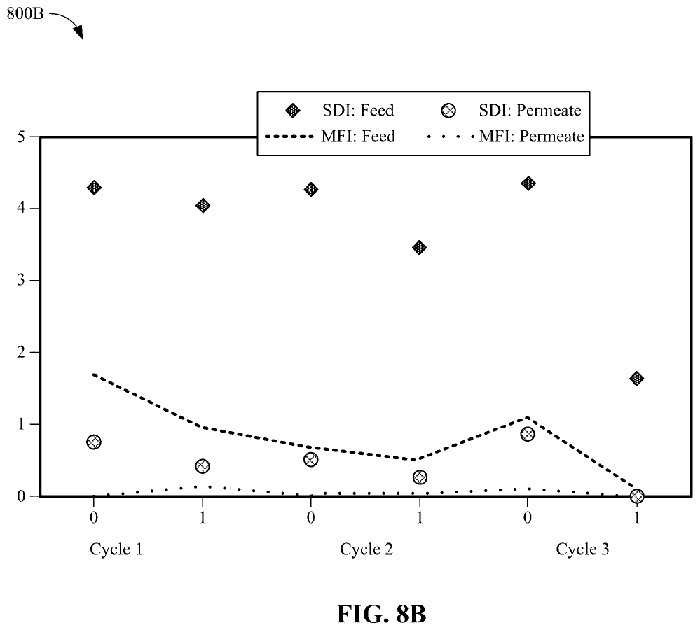

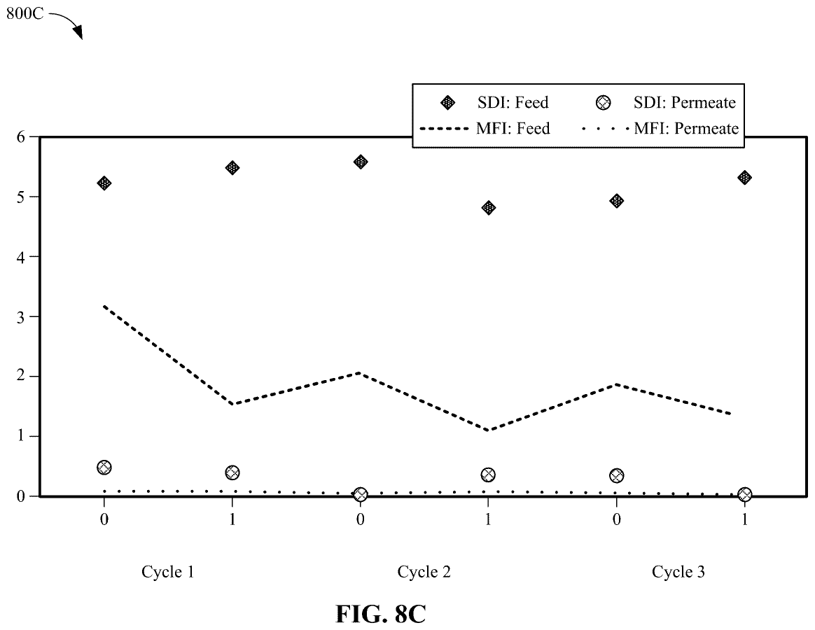

FIG. 8A illustrates a chart 800A, which describes first experimental data related to silt density index (SDI) values and modified fouling index (MFI) values, in accordance with an embodiment of the present disclosure. The chart 800A shows the SDI values and the MFI values of the permeate of the graphene-based ultrafiltration unit 108 when the seawater stream 302 is provided as an input to the graphene-based ultrafiltration unit 108. The SDI value of the permeate of the graphene-based ultrafiltration unit 108 is in the range of 0.4 to 1 as shown in the chart 800A. Further, the MFI value of the permeate of the graphene-based ultrafiltration unit 108 is in the range of 0 to 0.2 as shown in the chart 800A.

FIG. 8B illustrates a chart 800B, which describes second experimental data related to SDI and MFI values, in accordance with an embodiment of the present disclosure. The chart 800B shows the SDI value and the MFI value of a feed and the permeate of the graphene-based ultrafiltration unit 108. In the chart 800B, “feed” refers to the input provided to the graphene-based ultrafiltration unit 108, and “permeate” refers to the output permeate of the graphene-based ultrafiltration unit 108. In the chart 800B, the feed is the output from the filtration unit 106. Particularly, the feed is the first filtered stream 304 that is stored in a reservoir after being output from the filtration unit 106. The chart 800B of FIG. 8B shows reduction of the SDI value and MFI value by the graphene-based ultrafiltration unit 108 when the feed is provided as input to the graphene-based ultrafiltration unit 108 at a first rate of flow and a first pressure value. Notably, the SDI value of the permeate of the graphene-based ultrafiltration unit 108 is in the range of 0 to 1 for each cycle as shown in the chart 800B, while the SDI value of the feed is in the range of 3 to 5 for most of the cycles as shown in the chart 800B. Further, the MFI value of the permeate of the graphene-based ultrafiltration unit 108 is in the range of 0 to 0.5 for each cycle as shown in the chart 800B, while the MFI value of the feed of the graphene-based ultrafiltration unit 108 is in the range of 0.5 to 2 for most of the cycles as shown in the chart 800B.

FIG. 8C illustrates a chart 800C, which describes third experimental data related to SDI and MFI values, in accordance with an embodiment of the present disclosure. The chart 800C shows reduction of the SDI value and MFI value by the graphene-based ultrafiltration unit 108 when a feed is provided as input to the graphene-based ultrafiltration unit 108 at a second rate of flow and a second pressure value. In the chart 800C, the feed is the output of the filtration unit 106. Particularly, the feed is the first filtered stream 304 that is stored in a reservoir after being output from the filtration unit 106. The SDI value of the permeate of the graphene-based ultrafiltration unit 108 is in the range of 0 to 1 for each cycle as shown in the chart 800C, while the SDI value of the feed is in the range of 4 to 6 for each cycle as shown in the chart 800C. Further, the MFI value of the permeate of the graphene-based ultrafiltration unit 108 is in the range of 0 to 0.5 for each cycle as shown in the chart 800C, while the MFI value of the feed of the graphene-based ultrafiltration unit 108 is in the range of 1 to 3 for each cycle as shown in the chart 800C.

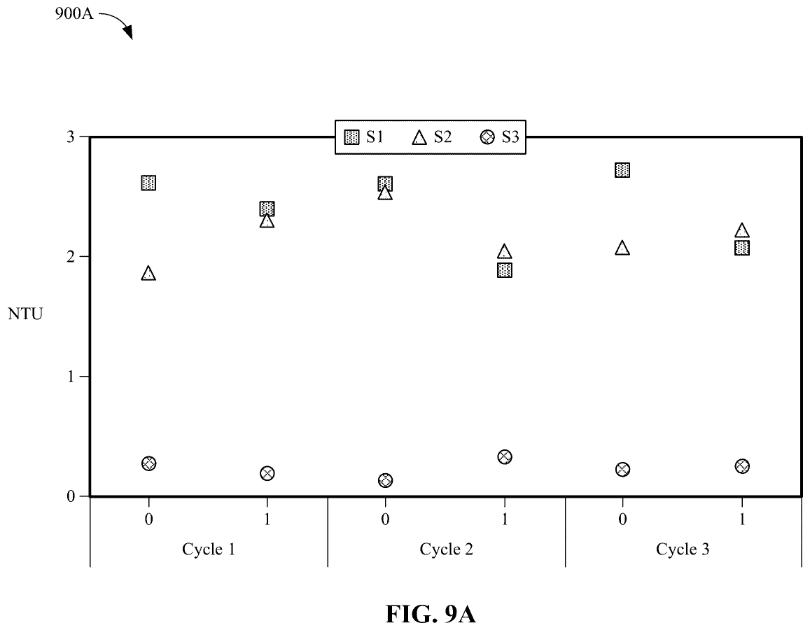

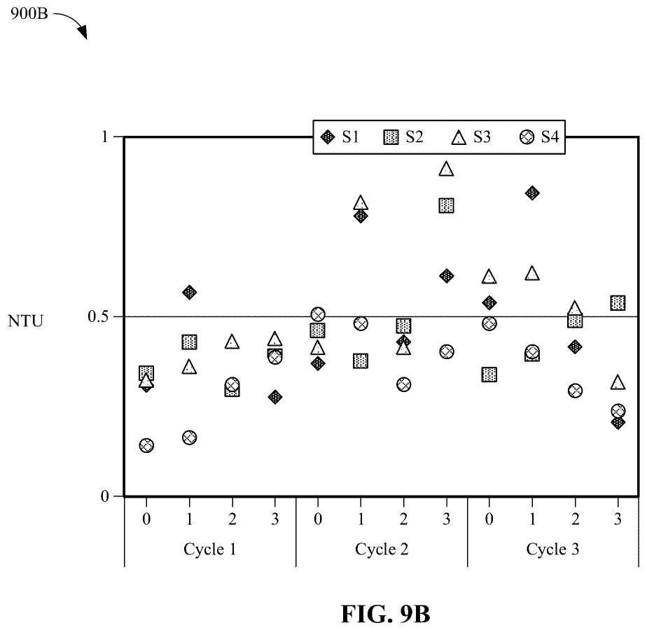

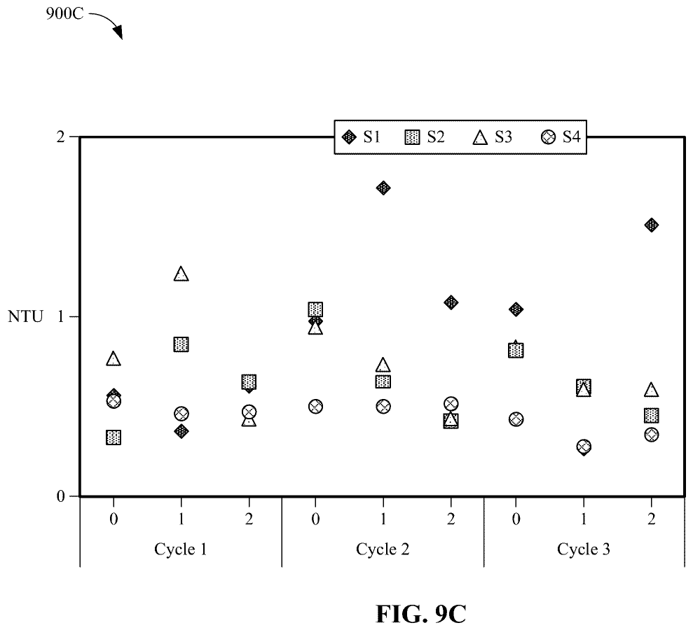

FIG. 9A illustrates a chart 900A, which describes first experimental data related to reduction in turbidity, in accordance with an embodiment of the present disclosure. The chart 900A shows reduction of turbidity value by the graphene-based ultrafiltration unit 108 when seawater is provided as input to the graphene-based ultrafiltration unit 108. In the chart 900A, S1 refers to the seawater such as the seawater stream 302, S2 refers to the output retentate of the graphene-based ultrafiltration unit 108, and S3 refers to the output permeate of the graphene-based ultrafiltration unit 108. The turbidity value of each of the S1 and the S2 in the chart 900A is in the range of 1.5 to 3 for each cycle as shown in the chart 900A, while the turbidity value of the S3 is in the range of 0 to 0.5 for each cycle, as shown in the chart 900A.

FIG. 9B illustrates a chart 900B, which describes second experimental data related to reduction in turbidity, in accordance with an embodiment of the present disclosure. The chart 900B shows reduction of turbidity value by the graphene-based ultrafiltration unit 108 when a filtered stream such as, the first filtered stream 304, is provided as input to the graphene-based ultrafiltration unit 108 at a first rate of flow and a first pressure value. In an embodiment of the disclosure, the first filtered stream 304 is stored in a reservoir before being provided to the graphene-based ultrafiltration unit 108. Thus, in the chart 900B, S1 refers to the filtered stream output from the filtration unit 106. Further, in the chart 900B, S2 refers to the stream that is provided as input to the graphene-based ultrafiltration unit 108 from the reservoir. Pertinently, the S2 may contain a greater amount of the one or more microbial matters as compared to the amount of the one or more microbial matters contained in S1. Further, in the chart 900B, S3 refers to the output retentate of the graphene-based ultrafiltration unit 108, and S4 refers to the output permeate of the graphene-based ultrafiltration unit 108. As shown in chart 900B, the turbidity value of the S1, the S2, and the S3 is in a range of 0.25 to 1 nephelometric turbidity units (NTU) in each cycle as shown in the chart 900B. Further, the turbidity value of the S4 is in a range of 0.1 to 0.5 as shown in the chart 900B.

FIG. 9C illustrates a chart 900C, which describes third experimental data related to reduction in turbidity, in accordance with an embodiment of the present disclosure. The chart 900C shows reduction of turbidity value by the graphene-based ultrafiltration unit 108 when a filtered stream such as, the first filtered stream 304, is provided as input to the graphene-based ultrafiltration unit 108 at a second rate of flow and a second pressure value. As shown in chart 900C, the turbidity value of the S1, the S2, and the S3 is in an approximate range of 0.25 to 2 NTU in each cycle as shown in the chart 900C. Further, the turbidity value of the S4 in 900C is in an approximate range of 0.2 to 0.5 as shown in the chart 900C.

Many modifications and other embodiments of the inventions set forth herein will come to mind to one skilled in the art to which these inventions pertain to having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. For example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A method for pre-treatment of seawater, comprising:
controlling a supply of a seawater stream to a filtration unit of a pre-treatment unit, wherein the filtration unit outputs a first filtered stream based on the supply of the seawater stream;
controlling a supply of the first filtered stream to a graphene-based ultrafiltration unit of the pre-treatment unit, wherein the graphene-based ultrafiltration unit outputs a second filtered stream based on the supply of the first filtered stream;
controlling a supply of the second filtered stream to a seawater reverse osmosis (SWRO) membrane unit; and
controlling an outlet of the SWRO membrane unit to output a desalinated stream based on the supply of the second filtered stream.

2. The method of claim 1, wherein the graphene-based ultrafiltration unit comprises a plurality of membranes stacked adjacent to each other, and wherein each of the plurality of membranes comprises a substrate and one or more graphene oxide layers arranged on at least one side of the substrate.

3. The method of claim 2, wherein a number of the one or more graphene oxide layers arranged on the substrate of a specific membrane of the plurality of membranes is in a range of 40 to 60, and wherein a thickness of each of the one or more graphene oxide layers is in a range of 0.5 nanometres (nm) to 1.5 nm.

4. The method of claim 2, wherein the substrate comprises polyvinylidene fluoride (PVDF).

5. The method of claim 1, wherein the filtration unit corresponds to at least one of: a gravity-based multimedia filtration unit, a pressurized multimedia-based filtration unit, a membrane-based filtration unit, or an ultrafiltration unit.

6. The method of claim 1, wherein
the filtration unit filters each of: a first portion of one or more particulate matters from the seawater stream, and a first portion of one or more microbial matters from the seawater stream, and
the graphene-based ultrafiltration unit filters each of: a second portion of the one or more particulate matters from the first filtered stream, and a second portion of the one or more microbial matters from the first filtered stream.

7. The method of claim 6, wherein
a first summation of the first portion of one or more particulate matters, the first portion of one or more microbial matters, the second portion of the one or more particulate matters and the second portion of the one or more microbial matters corresponds to a total amount of a plurality of entities filtered from the seawater stream to produce the second filtered stream,
each of the plurality of entities corresponds to one of: the one or more particulate matters, or the one or more microbial matters, and
a percentage of the total amount of the plurality of entities filtered from the seawater stream to produce the second filtered stream is in a range of 98.5% to 100%.

8. The method of claim 7, wherein the supply of the second filtered stream to the SWRO membrane unit causes an accumulation of a first quantity of the plurality of entities over a predefined time period on one or more membrane layers in the SWRO membrane unit, such that the first quantity is less than a fouling threshold of the SWRO membrane unit.

9. The method of claim 1, wherein a set of characteristics is associated with the second filtered stream, and wherein the set of characteristics is associated with at least one of: a dissolved organic carbon removal value of the second filtered stream, a silt density index (SDI) value of the second filtered stream, a bio-polymer removal value of the second filtered stream, a turbidity value of the second filtered stream, or a modified fouling index (MFI) value of the second filtered stream.

10. The method of claim 9, wherein at least one of:
the bio-polymer removal value of the second filtered stream is in a range of 65% to 100%,
the dissolved organic carbon removal value of the second filtered stream is in a range of 35% to 100%,
the SDI value of the second filtered stream is in a range of 0 to 1,
the turbidity value of the second filtered stream is in a range of 0 to 0.5 nephelometric turbidity units (NTU), or
the MFI value of the second filtered stream is in a range of 0 to 0.5.

11. The method of claim 1, wherein the seawater stream, the first filtered stream and the second filtered stream are independent of each chemical agent from a set of pre-treatment chemical agents, and wherein the set of pre-treatment chemical agents comprises at least one of: ferric chloride, sodium hypochlorite, chlorine dioxide, or sulphuric acid.

12. The method of claim 1, wherein an amount of total dissolved solids (TDS) in the seawater stream is in a range among a set of ranges, wherein the set of ranges comprises: 12000 to 20000 parts per million (ppm), and 32000 to 50000 ppm.

13. An apparatus, comprising:
a pre-treatment unit comprising a filtration unit and a graphene-based ultrafiltration unit;
a seawater reverse osmosis (SWRO) membrane unit comprising one or more membrane layers; and
a controller comprising one or more processors, wherein the one or more processors are configured to:
control a supply of a seawater stream to the filtration unit of the pre-treatment unit, wherein the filtration unit outputs a first filtered stream based on the supply of the seawater stream;
control a supply of the first filtered stream to the graphene-based ultrafiltration unit of the pre-treatment unit, wherein the graphene-based ultrafiltration unit outputs a second filtered stream based on the supply of the first filtered stream;
control a supply of the second filtered stream to the SWRO membrane unit; and
control an outlet of the SWRO membrane unit to output a desalinated stream based on the supply of the second filtered stream.

14. The apparatus of claim 13, wherein the graphene-based ultrafiltration unit comprises a plurality of membranes stacked adjacent to each other, and wherein each of the plurality of membranes comprises a substrate and one or more graphene oxide layers arranged on at least one side of the substrate, and wherein a number of the one or more graphene oxide layers arranged on the substrate of a specific membrane of the plurality of membranes is in a range of 40 to 60, and wherein a thickness of each of the one or more graphene oxide layers is in a range of 0.5 nanometres (nm) to 1.5 nm.

15. The apparatus of claim 13, wherein
the filtration unit filters each of: a first portion of one or more particulate matters from the seawater stream, and a first portion of one or more microbial matters from the seawater stream, and
the graphene-based ultrafiltration unit filters each of: a second portion of the one or more particulate matters from the first filtered stream, and a second portion of the one or more microbial matters from the first filtered stream.

16. The apparatus of claim 15, wherein
a first summation of the first portion of one or more particulate matters, the first portion of one or more microbial matters, the second portion of the one or more particulate matters and the second portion of the one or more microbial matters corresponds to a total amount of a plurality of entities filtered from the seawater stream to produce the second filtered stream,
each of the plurality of entities corresponds to one of: the one or more particulate matters, or the one or more microbial matters, and
a percentage of the total amount of the plurality of entities filtered from the seawater stream to produce the second filtered stream is in a range of 98.5% to 100%.

17. The apparatus of claim 16, wherein the supply of the second filtered stream to the SWRO membrane unit causes an accumulation of a first quantity of the plurality of entities over a predefined time period on one or more membrane layers in the SWRO membrane unit, such that the first quantity is less than a fouling threshold of the SWRO membrane unit.

18. The apparatus of claim 13, wherein the seawater stream, the first filtered stream and the second filtered stream are independent of each chemical agent from a set of pre-treatment chemical agents, and wherein the set of pre-treatment chemical agents comprises at least one of: ferric chloride, sodium hypochlorite, chlorine dioxide, or sulphuric acid.

19. A controller comprising:
one or more processors configured to:
control a supply of a seawater stream to a filtration unit of a pre-treatment unit, wherein the filtration unit outputs a first filtered stream based on the supply of the seawater stream;
control a supply of the first filtered stream to a graphene-based ultrafiltration unit of the pre-treatment unit, wherein the graphene-based ultrafiltration unit outputs a second filtered stream based on the supply of the first filtered stream;
control a supply of the second filtered stream to a seawater reverse osmosis (SWRO) membrane unit; and
control an outlet of the SWRO membrane unit to output a desalinated stream based on the supply of the second filtered stream.

20. The controller of claim 19, wherein the graphene-based ultrafiltration unit comprises a plurality of membranes stacked adjacent to each other, and wherein each of the plurality of membranes comprises a substrate and one or more graphene oxide layers arranged on at least one side of the substrate.
